(19) United States
(12) Patent Application Publication
(10) Pub. No.: US 2026/0133607 A1
(43) Pub. Date: May 14, 2026

(54) FOLDABLE ELECTRONIC DEVICE INCLUDING BUFFER MEMBER

(71) Applicant: SAMSUNG ELECTRONICS CO., LTD., Suwon-si (KR)

(72) Inventors: Minsu JUNG, Suwon-si (KR); Yunsu KIM, Suwon-si (KR); Jaeil SEO, Suwon-si (KR)

(21) Appl. No.: 19/375,209

(22) Filed: Oct. 31, 2025

Related U.S. Application Data
(63) Continuation of application No. PCT/KR2025/016337, filed on Oct. 16, 2025.

(30) Foreign Application Priority Data
Nov. 11, 2024 (KR) 10-2024-0159460
Dec. 11, 2024 (KR) 10-2024-0183974

(51) Int. Cl. G06F 1/16

(52) U.S. Cl. CPC G06F 1/1656; G06F 1/1641; G06F 1/1652

(57) ABSTRACT

A foldable electronic device includes a foldable housing a flexible display disposed inside the foldable housing, configured to be folded or unfolded with respect to a folding axis of the foldable housing, and including a first layer part and a second layer part disposed over the first layer part, a first buffer member disposed between a side part of the flexible display and an inner surface of the foldable housing, and having a first elasticity being higher than that of the inner surface, and a second buffer member disposed between the side part of the flexible display and the first buffer member, and having a second elasticity being higher than that of the first buffer member.

### CROSS-REFERENCE TO RELATED APPLICATIONS

This application is a continuation application, under 35 U.S.C. §111(a), of International Patent Application No. PCT/KR2025/016337, filed on October 16, 2025, which claims priority to Korean Patent Application No. 10-2024-0159460, filed on November 11, 2024, and Korean Patent Application No. 10-2024-0183974, filed on December 11, 2024, the contents of which in their entirety are herein incorporated by reference.

### BACKGROUND

### 1. Field

Various embodiments disclosed in the disclosure relate to a foldable electronic device including a buffer member.

### 2. Description of the Related Art

A portable electronic device is used as a daily-life electronic device that is used by almost all people, with advancements in communication technology and display technology. Many users use functions for making calls with others, searching for and collecting information through web access, or providing information, without being restricted by place or time. Most of the usage time of current portable electronic devices is focused on searching for information. Users feel a need for faster searching for and identifying of information, and, in relation to this, users demand a larger display panel.

When a display panel becomes larger, a size of a portable electronic device needs to be increased, and a weight of the device may also increase due to the increase in the size of the device. Accordingly, when a display panel becomes larger, portability of a portable electronic device may be reduced, and, in addition, a vulnerability, in which the device may be easily deformed or damaged by an external impact, may occur. To supplement this, researches on various forms of display panels continue to be conducted. As an example, in a foldable electronic device, a display may be unfolded or folded as desired, so that portability may be maintained while a size of the device may be kept at a predetermined size or less.

### SUMMARY

A foldable electronic device described in the disclosure may include a foldable housing, a flexible display disposed inside the foldable housing, configured to be folded or unfolded with respect to a folding axis of the foldable housing, and including a first layer part and a second layer part disposed over the first layer part, a first buffer member, and disposed between a side part of the flexible display and an inner surface of the foldable housing, and having a first elasticity being higher than that of the inner surface, and a second buffer member disposed between the side part of the flexible display and the first buffer member, and having a second elasticity being higher than that of the first buffer member.

### DESCRIPTION OF DRAWINGS

The above and other embodiments, advantages and features of this disclosure will become more apparent by describing in further detail embodiments thereof with reference to the accompanying drawings.

FIG. 1 is a front perspective view of an embodiment of a foldable electronic device.

FIG. 2 is a rear plan view of an embodiment of a foldable electronic device.

FIG. 3 is a partially exploded perspective view of an embodiment of the electronic device of FIGS. 1 and 2 including a hinge device.

FIG. 4 is a view illustrating an embodiment of an unfolded state of a display of a foldable electronic device.

FIG. 5 is a view illustrating an embodiment of a portion of a cross section of a display of a foldable electronic device.

FIG. 6 is a view illustrating an embodiment of a portion of a cross section of a foldable electronic device.

FIG. 7 is a view illustrating an embodiment of a first modified buffer member of a foldable electronic device.

FIG. 8 is a view illustrating an embodiment of a portion of a cross section of a foldable electronic device.

FIGS. 9A and 9B are views illustrating embodiments of a portion of a cross section of a foldable electronic device.

FIG. 10 is a view illustrating an embodiment of a portion of a cross section of a foldable electronic device.

FIG. 11 is a view illustrating embodiments of a portion of a cross section of a foldable electronic device.

FIG. 12 is a plan view illustrating an embodiment of a foldable electronic device.

FIG. 13 is a plan view illustrating an embodiment of a foldable electronic device.

The same or similar reference numerals may be used for the same or similar components in the drawings.

### DETAILED DESCRIPTION

Hereinafter, various embodiments of the disclosure may be described with reference to accompanying drawings. However, this is not intended to limit the disclosure to illustrative embodiments, and it should be understood to include various modifications, equivalents, and/or alternatives of the embodiments of the disclosure.

The disclosure described below may provide a foldable electronic device that is capable of reducing display stress caused by slip of the display during a folding operation of the electronic device (or a display, a foldable housing) and securing the robustness of a buffer structure against external forces. Furthermore, the foldable electronic device of the disclosure may minimize or reduce a slip amount by applying a step to the display to interrupt slip that continuously increases from a neutral plane. In addition, the foldable electronic device of the disclosure may remove a protective decoration, thereby improving aesthetics and reducing a black matrix due to the removal of the protective decoration.

Besides, a variety of effects directly or indirectly understood through the disclosure may be provided.

Hereinafter, various structures and disposition of a foldable electronic device including an antenna of the disclosure, and a relationship with peripheral structures will be described with reference to the drawings.

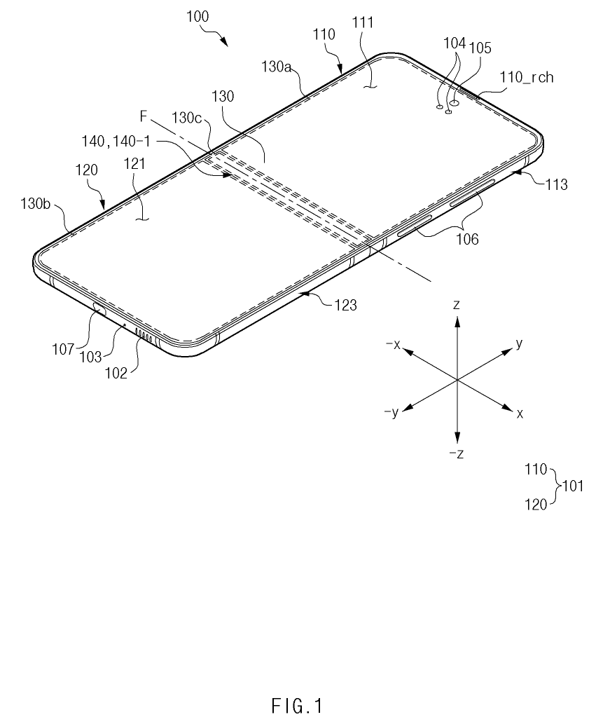

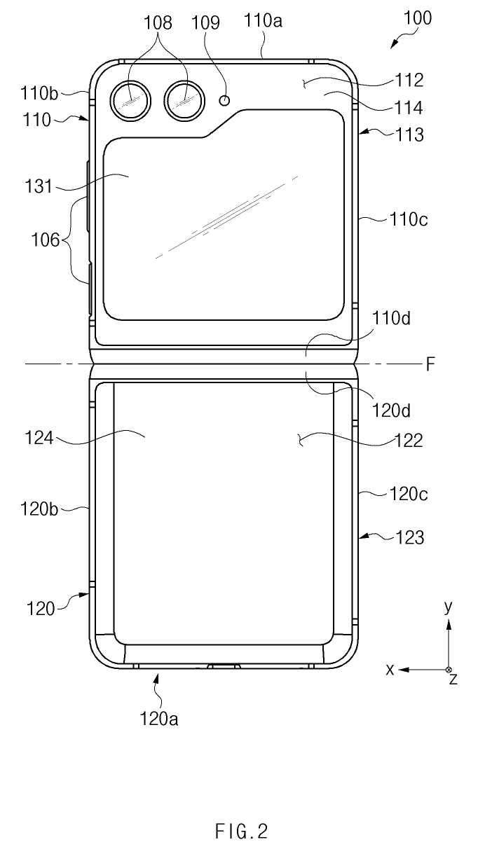

FIG. 1 is a front perspective view of an embodiment of a foldable electronic device. FIG. 2 is a rear plan view of an embodiment of a foldable electronic device.

Referring to FIGS. 1 and 2, the foldable electronic device 100 may include a first housing 110 (e.g., a first housing structure) including a first side member 113 (e.g., a side bezel) and a second housing 120 (e.g., a second housing structure) including a second side member 123 (e.g., a side bezel), wherein the first housing 110 and the second housing 120 may be coupled to each other to be foldable with respect to each other around a folding axis F through at least one hinge device 140 and 140-1 (e.g., a hinge module or hinge structure). In an embodiment, the first housing 110 and the second housing 120 may be configured as a foldable housing (e.g., a housing structure), for example. In an embodiment, the foldable electronic device 100 may include a first display 130 (e.g., a flexible display, a foldable display, or a main display) that is disposed to be supported by the first housing 110 and the second housing 120, for example. In an embodiment, the first housing 110 may include a first surface 111, and a second surface 212 that faces an opposite direction (e.g., the -z-axis direction) to the first surface 111, for example. In an embodiment, the second housing 120 may include a third surface 121, and a fourth surface 122 that faces an opposite direction (e.g., the -z-axis direction) to the third surface 121, for example. In an embodiment, the first housing 110 may include a first rear cover 114 that is coupled to the first side member 113, for example. In an embodiment, the second housing 120 may include a second rear cover 124 that is coupled to the second side member 123, for example. In an embodiment, when the foldable electronic device 100 is in a fully unfolded first state (e.g., an unfolding state or an unfolded state), the first surface 111 and the third surface 121 may be operated to face substantially the same direction (e.g., the z-axis direction), for example. In an embodiment, when the foldable electronic device 100 is in a fully folded second state (e.g., a folding state or a folded state), the first surface 111 and the third surface 121 may be operated to face each other or to face opposite directions, for example. In an embodiment, the foldable electronic device 100 may be operated to be maintain in a third state (e.g., an intermediate state) between the first state and the second state, for example.

In an embodiment, a hole 110_rch, in which a receiver is disposed on a first surface 111 of the first housing 110, at least one sensor module 104 (e.g., a light sensor), and/or at least one first camera module 105 (e.g., an under-display camera (UDC)), may be defined in the foldable electronic device 100. In an embodiment, the foldable electronic device 100 may include at least one key 106 that is disposed on the first side member 113, for example. In an embodiment, the foldable electronic device 100 may include a second display 131 (e.g., a sub display), at least one second camera module 108, and/or a flash 109, which are disposed on a second surface 112 (e.g., a first rear cover 114) of the first housing 110, for example. In an embodiment, the second display 131 may be visible from the outside through at least a portion of the first rear cover 114, for example. In an embodiment, the foldable electronic device 100 may include a speaker 102, a microphone 103, or a connector port 107 that is disposed on the second side member 123, for example. At least some of the plurality of components described above may be disposed in the first housing 110 and/or the second housing 120 through changes.

In an embodiment, the first display 130 (e.g., a flexible display) may include a first area 130a (e.g., a first planar part) corresponding to at least a portion of the first surface 111, a second area 130b (e.g., a second planar part) corresponding to at least a portion of the third surface 121, and a third area 130c (e.g., a flexible part) that connects the first area 130a and the second area 130b and, in which the foldable electronic device 100 may be deformed in the second state (e.g., a folded state) and/or the third state (e.g., an intermediate state). In an embodiment, the third area 130c may be disposed in a position, in which the first display 130 at least partially overlaps at least one hinge device 140 and 140-1 when it is viewed from a top (e.g., in the z-axis direction), for example. In an embodiment, in the second state, the first display 130 may be disposed such that the first surface 111 and the third surface 121 face each other not to be viewed from the outside (e.g., an in-fold type), for example. In an embodiment, in the second state, the first display 130 may be disposed such that the first surface 111 and the third surface 121 face opposite directions to be viewed from the outside (e.g., an out-fold type), for example.

The first side member 113 may include a first side wall 110a that is disposed in a first direction (e.g., the x-axis direction) of the first housing 110 of the foldable electronic device 100, a second side wall 110b that is disposed in a second direction (e.g., the y-axis direction that is perpendicular to the first direction) of the first housing 110, and a third side wall 110c that is disposed in a third direction (e.g., the -x-axis direction that is opposite to the first direction) of the first housing 110. In addition, the first side member 113 may include a fourth side wall 110d that is disposed in a fourth direction (e.g., the -y-axis direction that is opposite to the second direction) of the first housing 110. The second side wall 110b and the fourth side wall 110d may be disposed between the first side wall 110a and the third side wall 110c. An upper periphery (e.g., the y-axis periphery) of the first side wall 110a may be connected to a left periphery (e.g., an x-axis periphery) of the second side wall 110b, a right periphery (e.g., the -x- axis periphery) of the second side wall 110b may be connected to an upper periphery (e.g., the y-axis periphery) of the third side wall 110c, a lower periphery (e.g., the -y-axis periphery) of the third side wall 110c may be connected to a right periphery (e.g., the -x-axis periphery) of the fourth side wall 110d, and a left periphery (e.g., an x-axis periphery) of the fourth side wall 110d may be connected to a lower periphery (e.g., the -y-axis periphery) of the first side wall 110a. Peripheries (e.g., peripheries in the z-axis direction) of the first to third side walls (also referred to as first to third side parts) 110a, 110b, and 110c may be disposed to surround one periphery of the first display 130.

The second side member 123 may include a fifth side wall 120a that is disposed in a first direction (e.g., the x-axis direction) of the second housing 120 of the foldable electronic device 100, a sixth side wall 120b that is disposed in a fourth direction (e.g., the -y-axis direction that is perpendicular to the first direction) of the second housing 120, and a seventh side wall 120c that is disposed in a third direction (e.g., the -x-axis direction that is opposite to the first direction) of the second housing 120. Furthermore, the second side member 123 may include an eighth side wall 120d that is disposed in the second direction (e.g., the y-axis direction that is opposite to the fourth direction) of the second housing 120. The sixth side wall 120b and the eighth side wall 120d may be disposed between the fifth side wall 120a and the seventh side wall 120c. With reference to the illustrated drawings, a lower periphery (e.g., the -y-axis periphery) of the fifth side wall 120a may be connected to a left periphery (e.g., an x-axis periphery) of the sixth side wall 120b, a right periphery (e.g., the -x-axis periphery) of the sixth side wall 120b may be connected to a lower periphery (e.g., the -y-axis periphery) of the seventh side wall 120c, a lower periphery (e.g., the -y-axis periphery) of the seventh side wall 120c may be connected to a right periphery (e.g., the -x-axis periphery) of the eighth side wall 120d, and a left periphery (e.g., an x-axis periphery) of the eighth side wall 120d may be connected to an upper periphery (e.g., the y-axis periphery) of the fifth side wall 120a. Peripheries (e.g., peripheries in the z-axis direction) of the fifth to seventh side walls (also referred to as fifth to seventh side parts) 120a, 120b, and 120c may be disposed to surround an opposite periphery of the first display 130. When the foldable electronic device 100 is unfolded (or in an unfolded state), the fourth side wall 110d and the eighth side wall 120d may be disposed to face each other or to be next (adjacent) to each other. When the foldable electronic device 100 is in a folded state, at least a portion of the fourth side wall 110d and at least a portion of the eighth side wall 120d may be spaced apart by a thickness of the hinge housing.

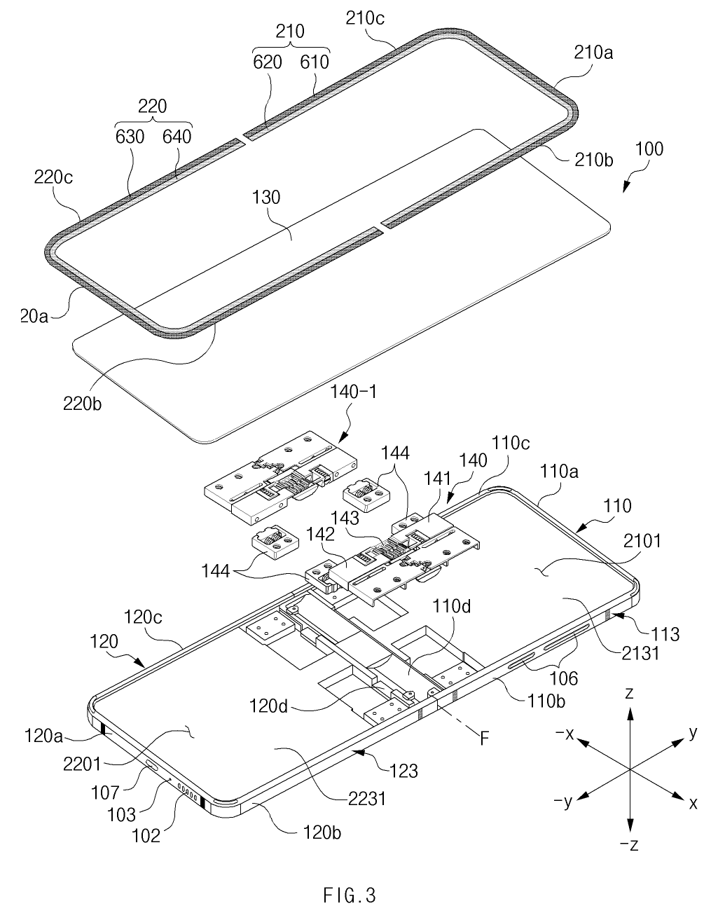

FIG. 3 is a partially exploded perspective view of an embodiment of the electronic device of FIGS. 1 and 2 including a hinge device.

Referring to FIGS. 1, 2, and 3, the foldable electronic device 100 may include at least one hinge device 140 and 140-1 (e.g., a hinge module or a hinge structure) that connects the first housing 110 and the second housing 120 beneath the first display 130 (e.g., in the -z-axis direction). In an embodiment, at least one hinge device 140 and 140-1 may include a first hinge device 140, and a second hinge device 140-1 that is spaced from the first hinge device 140 along a direction (e.g., a ±y-axis direction) that is parallel to the folding axis F, for example. In an embodiment, the at least one hinge device 140 and 140-1 may be supported by a first support member 2131 that extends from the first side member 113 into a first space 2101 of the first housing 110, and a second support member 2231 that extends from the second side member 123 into a second space 2201 of the second housing 120, for example. In an embodiment, the at least one hinge device 140 and 140-1 may be disposed between the first housing 110 and the second housing 120 not to be visible from the outside through the hinge housing 150 (e.g., a hinge cover), for example.

In an embodiment of the disclosure, the first hinge device 140 may include a first rotation member 141 (e.g., a first arm or a first rotator) that is disposed in the first support member 2131 of the first housing 110, a second rotation member 142 (e.g., a second arm or a second rotator) that is disposed in the second support member 2231 of the second housing 120, and a gear assembly 143 that is connected to the first rotation member 141 and the second rotation member 142 so that the first housing 110 and the second housing 120 may be rotated symmetrically with respect to each other. In an embodiment of the disclosure, the gear assembly 143 may include a plurality of gears that are enmeshed with each other (e.g., spur gears and/or worm gears). In an embodiment of the disclosure, the gear assembly 143 may include a cam engagement structure that presses the first housing 110 and the second housing 120 against each other in a direction, in which the first housing 110 and the second housing 120 are transitioned from a first state (e.g., an unfolded state) to a second state (e.g., a folded state) or in a direction, in which they are transitioned from the second state to the first state, and that provides a free stop at various folding angles. In an embodiment, the second hinge device 140-1 may be substantially symmetrical to or have substantially the same configuration as the first hinge device 140, for example.

In an embodiment of the disclosure, the foldable electronic device 100 may be interlocked with at least one hinge device 140 and 140-1, and may further include at least one detent module 144 (e.g., a detent module) for providing a stop feeling at various angles. In an embodiment of the disclosure, at least one hinge device 140 and 140-1 and/or the detent module 144 may allow the foldable electronic device 100 to define substantially the same plane as the first support member 2131 and the second support member 2231 when in a first state. In an embodiment, the second hinge device 140-1 may be substantially symmetrical to or have substantially the same configuration as the first hinge device 140, for example.

In an embodiment of the disclosure, the foldable electronic device 100 may include a first buffer structure 210 (e.g., an elastic member, a deformable member, a protective frame, a decorative member, an auxiliary frame, or an auxiliary housing) and a second buffer structure 220. The first buffer structure 210 and the second buffer structure 220 may be disposed substantially symmetrically with respect to a folding axis F.

In an embodiment of the disclosure, the first buffer structure 210 may include a first buffer area 210a that is disposed (or coupled) between a first side wall 110a and a first area 130a of the display 130, a second buffer area 210b that is disposed (or coupled) between a second side wall 110b and the first area 130a of the display 130, and a third buffer area 210c that is disposed (or coupled) between a third side wall 110c and the first area 130a of the display 130. The first buffer area 210a, the second buffer area 210b, and the third buffer area 210c may be connected to each other, but the foldable electronic device 100 of the disclosure is not limited thereto. In an embodiment, at least some of the first buffer area 210a, the second buffer area 210b, and the third buffer area 210c may be disposed in a separated state between respective side walls (e.g., first to third side walls 110a, 110b, and 110c) and a first area 130a of the first display 130, for example. The widths, lengths, and thicknesses of the first buffer area 210a, the second buffer area 210b, and the third buffer area 210c may be the same or similar, but the disclosure is not limited thereto. In an embodiment, the widths, lengths, and thicknesses of the first buffer area 210a, the second buffer area 210b, and the third buffer area 210c may be designed in consideration of a slip amount (or slip distance) of the first area 130a of the display 130 according to a folding operation of the display, for example. At least a portion of a material of the first buffer structure 210 may include or consist of a material different from a material (e.g., a metal material, an aluminum material, or an opaque material) of the first housing 110. The first buffer structure 210 may include or consist of a material having a light transmittance that is different from that of the first housing 110, or a material having a color that is different from that of the first housing 110. In an embodiment, at least a portion of the first buffer structure 210 may include or consist of a plastic structure, a polymer structure, a silicone structure, rubber, fiber, or any combinations thereof, for example.

In an embodiment of the disclosure, the second buffer structure 220 may include a fourth buffer area 220a that is disposed (or coupled) between a fifth side wall 120a and a second area 130b of the display 130, a fifth buffer area 220b that is disposed (or coupled) between a sixth side wall 120b and the second area 130b of the display 130, and a sixth buffer area 220c that is disposed (or coupled) between a seventh side wall 120c and the second area 130b of the display 130. The fourth buffer area 220a, the fifth buffer area 220b, and the sixth buffer area 220c may be connected to each other, but the foldable electronic device 100 of the disclosure is not limited thereto. In an embodiment, at least some of the fourth buffer area 220a, the fifth buffer area 220b, and the sixth buffer area 220c may be disposed in a separated state between respective side walls (e.g., fifth to seventh side walls 120a, 120b, and 120c) and a second area 130b of the first display 130. The widths, lengths, and thicknesses of the fourth buffer area 220a, the fifth buffer area 220b, and the sixth buffer area 220c may be the same or similar, for example, but the disclosure is not limited thereto. In an embodiment, widths, lengths, and thicknesses of the fourth buffer area 220a, the fifth buffer area 220b, and the sixth buffer area 220c may be designed in consideration of a slip amount (or a slip distance) of the second area 130b of the display 130 according to a folding operation of the display 130, for example. At least a portion of a material of the second buffer structure 220 may include or consist of a material different from a material (e.g., a metal material, an aluminum material, or an opaque material) of the second housing 120. The second buffer structure 220 may include or consist of a material having a light transmittance that is different from that of the second housing 120, or a material having a color that is different from that of the second housing 120. In an embodiment, at least a portion of the second buffer structure 220 may include or consist of a plastic structure, a polymer structure, a silicone structure, rubber, fiber, or any combinations thereof, for example.

In an embodiment, the first buffer structure 210 may include a first buffer member 610 and a second buffer member 620. The first buffer member 610 may be disposed between the first side member 113 of the first housing 110 and the first area 130a of the display 130. The first buffer member 610 may be formed along the periphery of the first area 130a of the display. In an embodiment, the first buffer member 610 may define a C-shaped structure or a partial band (or an angled shape or a curved shape), one side of which is opened toward the -y axis, for example. The second buffer member 620 may be disposed between the first buffer member 610 and the first area 130a of the display 130. The second buffer member 620 may be formed along a periphery of the first buffer member 610. In an embodiment, the second buffer member 620 may define a C-shaped structure or a partial band (or an angled shape or a curved shape), one side of which is opened toward the -y axis, for example.

In an embodiment, the second buffer structure 220 may include a third buffer member 630 and a fourth buffer member 640. The third buffer member 630 may be disposed between the second side member 123 of the second housing 120 and the second area 130b of the display 130. The third buffer member 630 may be formed along the periphery of the second area 130b of the display 130. In an embodiment, the third buffer member 630 may define a C-shaped structure or a partial band (or an angled shape or a curved shape), one side of which is opened toward the y axis. The third buffer member 630 may be substantially symmetrical with the first buffer member 610 with respect to the folding axis F, for example. The fourth buffer member 640 may be disposed between the third buffer member 630 and the first area 130a of the display 130. The fourth buffer member 640 may be formed along a periphery of the third buffer member 630. In an embodiment, the fourth buffer member 640 may define a C-shaped structure or a partial band (or an angled shape or a curved shape), one side of which is opened toward the y axis, for example. The fourth buffer member 640 may be substantially symmetrical with the second buffer member 620 with respect to the folding axis F.

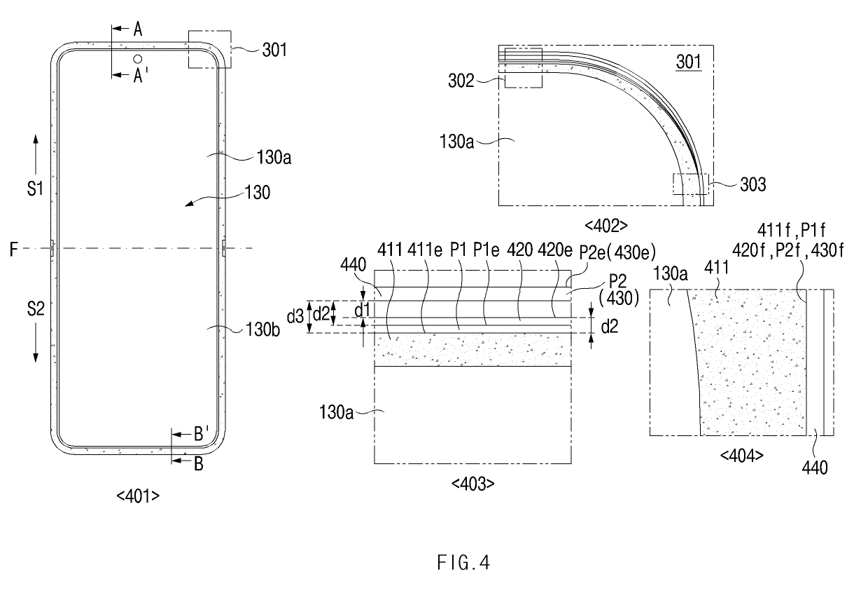

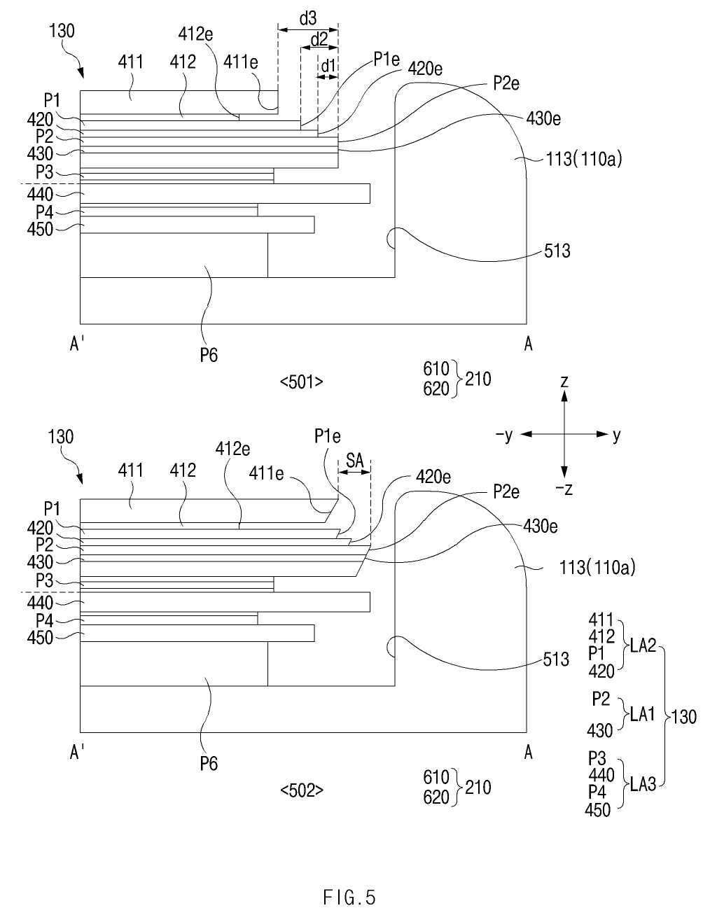

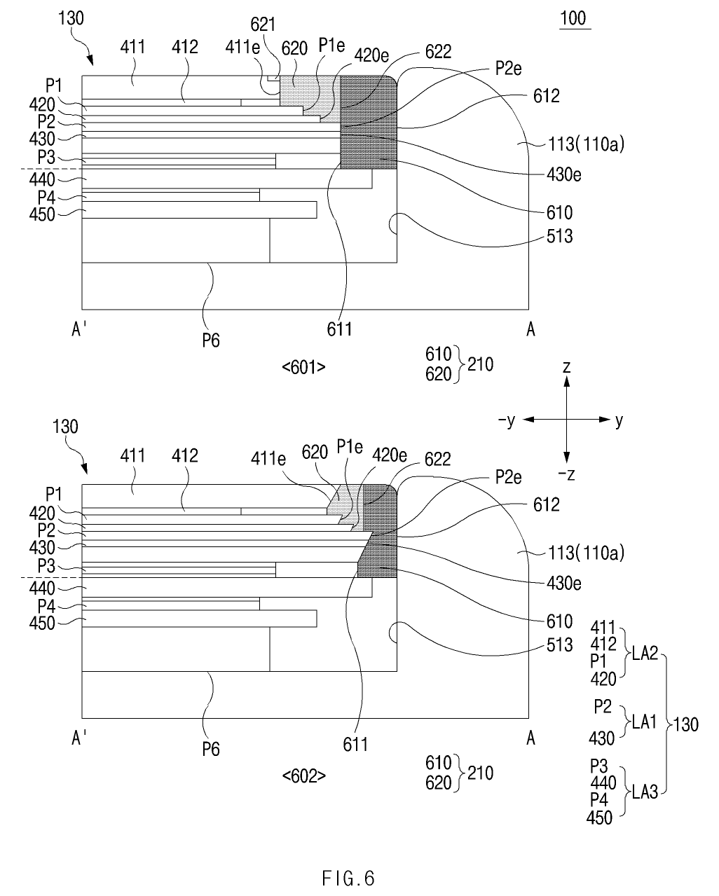

FIG. 4 is a view illustrating an embodiment of an unfolded state of a display of a foldable electronic device, FIG. 5 is a view illustrating an embodiment of a portion of a cross section of the display of the foldable electronic device, and FIG. 6 is a view illustrating an embodiment of a portion of a cross section of the foldable electronic device. In an embodiment, in FIG. 4, <401> is a plan view illustrating an unfolded state of a display included in the foldable electronic device, <402> is a view illustrating an enlarged view of area 301 of <401>, <403> is a view illustrating an enlarged view of area 302 of <402>, and <404> is a view illustrating an enlarged view of area 303 of <402>. In FIG. 5, <501> is a view illustrating an unfolded state of the display of the foldable electronic device, taken along cutting line A-A’ of FIG. 4, and <502> is a view illustrating a folded state of the display of the foldable electronic device, taken along line A-A’ of FIG. 4. In FIG. 6, <601> is a view illustrating an unfolded state of the foldable electronic device including a buffer member, taken along cutting line A-A’ of FIG. 4, and <602> is a view illustrating a folded state of the foldable electronic device including a buffer member, taken along line A-A’ of FIG. 4.

In the following descriptions of FIGS. 5 and 6, a structure of the first housing 110 and the first buffer structure 210, taken along cutting line A-A’, will be illustrated and described as an example. When cutting line A-A’ is applied to a predetermined position of the second housing (the second housing 120 of FIGS. 1 to 3) and the second buffer structure (the second buffer structure 220 of FIG. 3), at least a portion of cut surfaces of the fifth side wall 120a of a second side member 123 included in the second housing 120 and the second buffer structure 220 may be the same as or similar to cut surfaces of the first side wall 110a of a first side member 113 included in the first housing 110 and the first buffer structure 210.

Referring to FIGS. 1 to 6, in an embodiment, the electronic device may include a display 130, a foldable housing (e.g., the foldable housing 101 of FIGS. 1 to 3), and buffer members 610 and 620.

In an embodiment, the display 130 may include a plurality of layers. In an embodiment, the display 130 may include a metal sheet 450, a support plate 440, a display panel 430, a polarizing member 420, a glass layer 412, and a polymer layer 411. In an embodiment, in the display 130, the metal sheet 450, the support plate 440, the display panel 430, the polarizing member 420, the glass layer 412, and the polymer layer 411 may be sequentially stacked. The display 130 illustrated in FIG. 5 is merely one example provided for describing an embodiment, and all components included in the display 130 illustrated in FIG. 5 may not be essential components. Accordingly, the display 130 may be configured by omitting some of the components illustrated in FIG. 5 or by adding some components.

In an embodiment, the glass layer 412, the polarizing member 420, the display panel 430, the support plate 440, and the metal sheet 450 may be attached to each other through adhesive members P1, P2, P3, and P4. In an embodiment, the adhesive members P1, P2, P3, and P4 may include at least one of an optical clear adhesive (OCA), a pressure sensitive adhesive (PSA), a thermal reaction adhesive, a light reaction adhesive, or a double-sided tape, for example.

In an embodiment, at least any one of the support plate 440, the display panel 430, the polarizing member 420, the glass layer 412, and the polymer layer 411 may be disposed to cross at least a portion of the folding axis F.

In an embodiment, the window may include at least any one of the polymer layer 411 and the glass layer 412. At least a portion of the polymer layer 411 may be exposed to the outside through a front surface (e.g., a surface that faces the z-axis) of the electronic device. The polymer layer 411 may be disposed on the glass layer 412 to protect the glass layer 412. In an embodiment, the glass layer 412 may include ultra thin glass (UTG). The polymer layer 411 may include polyethylene terephthalate (PET) and/or polyimide (PI), for example. The display panel 430 may include a plurality of pixels for displaying an image. The display panel 430 may include an organic light-emitting diode (OLED) panel, a liquid crystal display (LCD) panel, or a quantum dot light-emitting diode (QLED) panel. The display panel 430 may further include a touch sensor, in which electrodes for receiving touch input, fingerprint recognition, or pen input are disposed. In an embodiment, the display panel 430 and the polarizing member 420 may be integrally formed (or unitary). The support plate 440 may be disposed under the display panel 430. The support plate 440 may provide a dark background for securing the visibility of the display panel 430, and may be formed as a buffering material for a buffering operation. In an embodiment, the support plate 440 may also be disposed under the display panel 430, the polarizing member 420, and/or the metal sheet 450. The metal sheet 450 may define a rear surface of the display 130. The metal sheet 450 may include or consist of a metal material having rigid properties. The metal sheet 450 may include a lattice structure defining an opening that extends in a direction of the folding axis F. The lattice structure may be disposed in an area corresponding to the third area of the display 130.

The electronic device in an embodiment may define a step (or a stepped shape) at at least a portion of the display in consideration of a slip phenomenon of the display due to a folding operation.

In an embodiment, when the display 130 is formed with a multilayer structure, a plurality of layers that constitutes the display 130 may each experience a slip when they are folded with respect to the folding axis F. In an embodiment, when the electronic device 100 is transitioned from a first state (e.g., the unfolded state of FIG. 2A) to a second state (e.g., the folded state of FIG. 2B), the third area (also referred to as a folding area) 130c of a layer that is next (adjacent) to a front surface of the display 130 may have a relatively larger curvature compared to the folding area 130c of a layer that is next (adjacent) to a rear surface of the display 130, for example. Accordingly, each layer that constitutes the display 130 may slip in a slip direction S1 or S2 that is a direction (e.g., the y-axis direction and the -y-axis direction of FIG. 4B) that is perpendicular to the folding axis F, during a folding process of the electronic device 100. A slip amount of a layer that is next (adjacent) to a front surface of the display 130 may be greater than that of at least any one of the remaining layers included in the display 130. In a direction (e.g., the x-axis direction and the -x-axis direction of FIG. 4B) that is parallel to the folding axis F, a slip phenomenon of the display may not occur or may occur to a lesser extent than in a direction that is perpendicular to the folding axis F.

In an embodiment, a plurality of layers included in the display may be classified into a first layer part LA1, a second layer part LA2, and a third layer part LA3. The first layer part LA1 may be disposed between the second layer part LA2 and the third layer part LA3. The second layer part LA2 may be disposed over the first layer part LA1. The second layer part LA2 may be stacked in a stepped shape on the first layer part LA1. The second layer part LA2 may include at least one layer that is disposed on the z-axis with respect to a neutral plane NP. The third layer part LA3 may be disposed under the first layer part LA1. The third layer part LA3 may include at least one layer that is disposed on the z axis with respect to a neutral plane NP. In an embodiment, the neutral plane NP may be an imaginary plane that maintains a constant length without a change in length when the display is transitioned from an unfolded state to a folded state. A slip may occur starting from a layer that is disposed on an upper side (e.g., the +z-axis) with respect to the neutral plane NP. As the distance from the neutral plane NP increases, a slip amount (or slip distance) may increase.

In an embodiment, the neutral plane NP may be disposed at an interface between a lower layer (e.g., the support plate 440) and an upper layer (e.g., the third adhesive member P3) that are sequentially stacked between the metal sheet 450 and the display panel 430. In an embodiment, the neutral plane NP may be formed in a direction that is parallel to the y-axis direction within any one of a plurality of layers that are disposed between the metal sheet 450 and the display panel 430. In an embodiment, the neutral plane NP may be formed closer to the display panel 430 than to the metal sheet 450, so that slip occurrence in the display panel 430 may be reduced or prevented. In an embodiment, in FIGS. 5 and 6, the neutral plane NP is illustrated as being disposed between the third adhesive member P3 and the support plate 440, but the disclosure is not limited thereto. The neutral plane NP in an embodiment may be changed into various forms due to a product structure, a design, or the like.

In an embodiment, the first layer part LA1 may include at least any one of the display panel 430, the second adhesive member P2, and the third adhesive member P3. The second layer part LA2 may be any one of a plurality of layers that are disposed on the display panel 430 and/or the second adhesive member P2. In an embodiment, the second layer part LA2 may include at least any one of the polymer layer 411, the glass layer 412, the polarizing member 420, and the first adhesive member P1. The third layer part LA3 may be at least any one of a plurality of layers that are disposed under the display panel 430. In an embodiment, the third layer part LA3 may include the support plate 440, the metal sheet 450, the fourth adhesive member P4, and a lower adhesive member P6.

In an embodiment, a plurality of layers included in the display of the foldable electronic device 100 may be disposed in a stacked structure having a stepped shape (or an inclined shape) in consideration of a slip amount (or slip distance) of the plurality of layers due to a folding operation of the foldable electronic device 100.

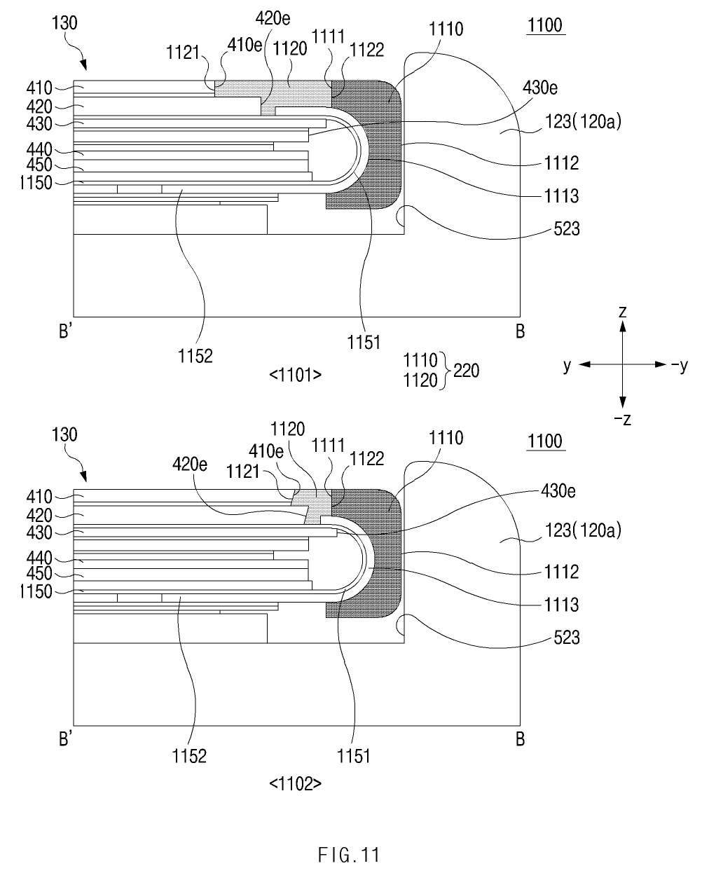

In an embodiment, the second layer part LA2 may be stacked in a stepped shape on the first layer part LA1. At least one layer included in the first layer part LA1 may have a first length (e.g., a length in the y-axis direction), and at least one layer included in the second layer part LA2 may have a second length (e.g., a length in the y-axis direction). At least one layer included in the first layer part LA1 may have a first length that is perpendicular to the folding axis F, and at least one layer included in the second layer part LA2 may have a second length that is perpendicular to the folding axis F. The second length may be smaller than the first length. At least some layers included in the second layer part LA2 may be stacked on the first layer part LA1 in a stepped shape, in which the layers become farther away from an inner surface 513 of the first side wall 110a of the first housing and/or an inner surface (e.g., the inner surface 523 of FIG. 11) of a fifth side wall 120a of the second housing 120 as they become farther in a thickness direction (e.g., the z-axis direction) away from the display panel 430, go toward an uppermost layer of the display (e.g., the polymer layer), or become farther away from the neutral plane NP. A plurality of layers included in the second layer part LA2 may be formed in a stepped shape, so that, during a folding operation of the display, a slip that is continuously and proportionally increased from the neutral plane may be divided (or separated or interrupted) across the respective layers. Side parts 411e, 412e, 420e, P1e, and P2e of the plurality of layers included in the second layer part LA2 may be separated from each other during a folding operation of the display,

so that a maximum slip amount of the display may be reduced or minimized. Compared to a comparative example, in which the plurality of layers included in the second layer part LA2 are not formed in a stepped shape, an embodiment, in which the plurality of layers included in the second layer part LA2 are formed in a stepped shape, may reduce a slip amount by 50% to 70%.

In an embodiment, the first layer part LA1 may not be formed in a stepped shape. The display panel 430 included in the first layer part LA1 may not be formed in a stepped shape with the second adhesive member P2. The display panel 430 may maintain a length relationship with at least any one of the second adhesive member P2 and the third adhesive member P3. The display panel 430 may not be formed in a stepped shape with the second adhesive member P2 so as not to affect a dead space of the display panel 430.

In an embodiment, the first side part (e.g., a part that faces the y-axis) of the first layer part that faces an inner surface 513 (e.g., a part that faces the -y-axis) of a first side wall 110a of the first housing 110 that is parallel to the folding axis F may be disposed to protrude farther than the second side part (e.g., a part that faces the y-axis) of the second layer part that faces the inner surface 513 of the first side wall 110a. The third side part (e.g., a part that faces the -y-axis) of the first layer part that faces an inner surface (e.g., a part that faces the y-axis) of a fifth side wall 120a of the second housing 120 that is parallel to the folding axis F may be disposed to protrude farther than the fourth side part (e.g., a part that faces the -y-axis) of the second layer part that faces the inner surface 513 of the fifth side wall 120a.

In an embodiment, the first side part (the side part 430e of the display panel 430) of the first layer part that faces an inner surface 513 of a first side wall 110a of a first side member 113 that is parallel to the folding axis F may be disposed to protrude farther than the second side part (e.g., the side part 411e of the polymer layer 411, the side part 412e of the glass layer 412, the side part 420e of the polarizing member 420, the side part P1e of the first adhesive member P1, and the side part P2e of the second adhesive member P2) of the second layer part that faces the inner surface 513 of the first side wall 110a. In an embodiment, the side part 430e of the display panel 430 that faces an inner surface 513 of the first housing 110 that is parallel to the folding axis F may protrude farther than the side part 411e of the polymer layer 411 and the side part 412e of the glass layer 412 that face the inner surface 513 of the first housing 110. The side part 412e of the glass layer 412 that faces the inner surface 513 of the first housing 110 may protrude farther than the side part 411e of the polymer layer 411 that faces the inner surface 513 of the first side wall 110a of the first housing 110.

In an embodiment, in a state, in which the electronic device is unfolded (or in an unfolded state), the side part P2e of the second adhesive member P2 and/or the side part 430e of the display panel 430, that are parallel to the folding axis F may protrude by a first protrusion length d1 (or the y-axis length, a length that is perpendicular to the folding axis) farther than the side part 420e of the polarizing member 420 that is parallel to the folding axis F. The first protrusion length d1 may be equal to or greater than a slip amount (or slip distance) of the polarizing member 420 when the electronic device is transitioned to a folded state. In an embodiment, the first protrusion length d1 may be 0.1 millimeter (mm). In an embodiment, in a state, in which the electronic device is unfolded (or in an unfolded state), the side part P2e of the second adhesive member P2 and/or the side part 430e of the display panel 430 that are parallel to the folding axis F may protrude by a second protrusion length d2 farther than the side part P1e of the first adhesive member P1 that is parallel to the folding axis F. The second protrusion length d2 may be equal to or greater than a slip amount (or slip distance) of the first adhesive member P1 when the electronic device is transitioned to a folded state. The second protrusion length d2 may be equal to or greater than the first protrusion length d1. In an embodiment, the second protrusion length d2 may be 0.25 mm. In an embodiment, in a state, in which the electronic device is unfolded (or in an unfolded state), the side part P2e of the second adhesive member P2 and/or the side part 430e of the display panel 430 that are parallel to the folding axis F may protrude by a third protrusion length d3 farther than the side part 411e of the polymer layer 411 that is parallel to the folding axis F. The third protrusion length d3 may be equal to or greater than a slip amount (or slip distance) of the polymer layer 411 when the electronic device is transitioned to a folded state. The third protrusion length d3 may be equal to or greater than the second protrusion length d2. In an embodiment, the third protrusion length d3 may be 0.4 mm.

In an embodiment, a separation distance (or the y-axis length, a length that is perpendicular to the folding axis) between the second side part of the second layer part that is parallel to the folding axis F and the inner surface 513 of the first side wall 110a may be larger than a separation distance between the first side part of the first layer part LA1 that is parallel to the folding axis F and the inner surface 513 of the first side wall 110a. In an embodiment, in a state, in which the electronic device is unfolded (or in an unfolded state), a separation distance between the side part 411e of the polymer layer 411 and/or the side part 412e of the glass layer 412 that are parallel to the folding axis F and the inner surface 513 of the first side wall 110a may be larger than a separation distance between the side part 430e of the display panel 430 that is parallel to the folding axis F and the inner surface 513 of the first side wall 110a. In an embodiment, a separation distance between the side part 411e of the polymer layer 411 and/or the side part P1e of the first adhesive member P1 that are parallel to the folding axis F and the inner surface 513 of the first side wall 110a may be larger than a separation distance between the side part 420e of the polarizing film 420 that is parallel to the folding axis F and the inner surface 513 of the first side wall 110a. In an embodiment, a separation distance between the side part 420e of the polarizing film 420 that is parallel to the folding axis F and the inner surface 513 of the first side wall 110a may be larger than a separation distance between the side part 430e of the display panel 430 and/or the side part P2e of the second adhesive member P2 and the inner surface 513 of the first side wall 110a.

In an embodiment, when the electronic device is folded (or in a folded state), a plurality of layers (or the second layer part LA2) that are disposed on the neutral plane NP may be spaced apart from an inner surface 513 so as to secure a slip space. In an embodiment, when the electronic device is folded (or in a folded state), a plurality of layers (or the second layer part LA2) that are disposed on the neutral plane NP may be stacked in a stepped shape in consideration of a slip amount. When the electronic device is transitioned (switched) from an unfolded state to a folded state, a plurality of layers (or the second layer part LA2) that are disposed on the neutral plane NP may not protrude farther than the first layer part LA1 (e.g., a side part 430e of the display panel 430) even when slipping occurs. Side parts 411e, 412e, 420e, P1e, and P2e of the plurality of layers included in the second layer part LA2 may be separated from each other during a folding operation of the display, so that a maximum slip amount SA of the display may be reduced or minimized.

In an embodiment, slip may not occur or may occur relatively less in at least some of a plurality of layers included in the display 130 in a direction that is parallel to the folding axis F. Side parts of a plurality of layers that are perpendicular to the folding axis F may not be formed in a stepped shape (or an inclined shape). A side part of the first layer part that is perpendicular to the folding axis F may not protrude farther than a side part of the second layer part that is perpendicular to the folding axis F. In an embodiment, a side part 430f of the display panel 430 that is perpendicular to the folding axis F and/or a side part P2f of the second adhesive member P2 that is perpendicular to the folding axis F may not protrude farther than any one of a side part 411f of the polymer layer 411 that is perpendicular to the folding axis F, a side part P1f of the first adhesive member P1 that is perpendicular to the folding axis F, a side part 420f of the polarizing film 420 that is perpendicular to the folding axis F, and a side part P1f of the second adhesive member P2 that is perpendicular to the folding axis F. In an embodiment, a side part 430f of the display panel 430 that is perpendicular to the folding axis F and/or a side part P2f of the second adhesive member P2 that is perpendicular to the folding axis F may be aligned in a direction perpendicular to the folding axis F with any one of the side part 411f of the polymer layer 411 that is perpendicular to the folding axis F, the side part P1f of the first adhesive member P1 that is perpendicular to the folding axis F, the side part 420f of the polarizing film 420 that is perpendicular to the folding axis F, and the side part P1f of the second adhesive member P2 that is perpendicular to the folding axis F.

In an embodiment, when the electronic device is unfolded (or in an unfolded state), the first buffer member 610 and the second buffer member 620 may be disposed (or filled) in empty spaces between the first layer part LA1 and the second layer part LA2 that are stacked in a stepped shape, and the first housing 110, respectively. The first buffer member 610 may have a first elasticity that is higher than that of the inner surface 513 of the first side wall 110a. In the description, when an elasticity (or modulus) of one element and an elasticity (or modulus) of another element are compared, the elasticity of one element and the elasticity of another element are measured at the same environmental condition (e.g., same temperature and/or same humidity). The second buffer member 620 may have a second elasticity that is higher than that of the first buffer member 610. In an embodiment, the first buffer member 610 may have a first modulus, and the second buffer member 620 may have a second modulus that is lower than the first modulus. In an embodiment, the first buffer member 610 may have a first modulus ranging from several tens of megapascals (MPa) to several hundreds of MPa (e.g., 50 MPa or more and 150 MPa or less), and the second buffer member 620 may have a second modulus of several MPa to several tens of MPa (e.g., 7 MPa or more and less than 50 MPa). In an embodiment, the first buffer member 610 may have a first elongation (e.g., an elongation of 50% to 100%), and the second buffer member 620 may have a second elongation that is higher than the first elongation (e.g., an elongation of 200% to 300%). In an embodiment, the first buffer member 610 may have a first hardness (or rigidity), and the second buffer member 620 may have a second hardness (or rigidity) that is lower than the first hardness.

The first buffer member 610 may be disposed between one side (e.g., a side that faces the y-axis) of the display and the inner surface 513 of the first housing. The first buffer member 610 may include or consist of a material that is less deformable than the second buffer member 620, so that damage (e.g., tearing or detachment) due to an external force may be reduced or prevented. The first buffer member 610 may protect the display against an external force, so that robustness to the external force may be secured.

The second buffer member 620 may be disposed between one side (e.g., a side that faces the y-axis) of the display and the first buffer member 610. When the electronic device is unfolded (or in an unfolded state), the second buffer member 620 may be disposed to contact a side part of the first layer part LA1 and a side part of the second layer part LA2. It may be formed to have a surface of a reverse stepped shape corresponding to side parts of the first layer part LA1 and the second layer part LA2 that are stacked in a stepped shape. The side parts of the stepped shapes of the first layer part LA1 and the second layer part LA2 in a stepped shape may be substantially symmetrical with a side surface of a reverse stepped shape of the second buffer member 620 with respect to the folding axis F.

The second buffer member 620 may include or consist of a material that is more deformable than the first buffer member 610, so that it may absorb a slip variation of the display panel 430 due to a folding operation of the display 130. At least a portion of the second buffer member 620 may be compressed toward the first buffer member 610 by the display 130 that slips when being converted from an unfolded state to a folded state.

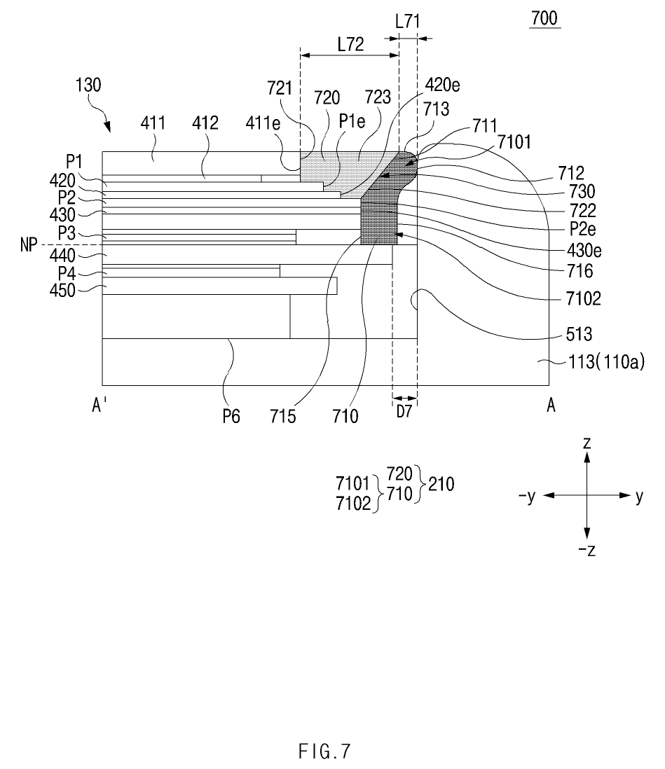

FIG. 7 is a view illustrating an embodiment of a portion of a cross section of a foldable electronic device. In an embodiment, FIG. 7 illustrated an embodiment of a cross section, taken along cutting line A-A’ of FIG. 4, and is a view illustrating an unfolded state of the foldable electronic device.

The foldable electronic device of FIG. 7 may be at least partially similar to at least one of the electronic devices of FIGS. 1 to 6, or may include other embodiments of the electronic device. The electronic device of FIG. 7 is identical to at least one of the previous embodiments of FIGS. 1 to 6, or for components that may be easily understood from the previous embodiments, the same reference numerals are assigned or omitted, and detailed descriptions thereof are also omitted.

Referring to FIG. 7, the foldable electronic device 100 may include the first housing 110, the first buffer structure 210, and the first display 130. In the following descriptions, a structure of the first housing 110 and the first buffer structure 210, taken along cutting line A-A’, will be illustrated and described as an example. When cutting line A-A’ is applied to a predetermined position of the second housing (the second housing 120 of FIGS. 1 to 6) and the second buffer structure (the second buffer structure 220 of FIG. 3), at least a portion of cut surfaces of the fifth side wall 120a of a second side member 123 included in the second housing 120 and the second buffer structure 220 may be the same as or similar to cut surfaces of the first side wall 110a of a first side member 113 included in the first housing 110 and the first buffer structure 210.

The first display 130 and a first side member 113 of the first housing 110 may include the same or similar components as the first display 130 and the first side member 113 of the first housing 110 described with reference to FIGS. 1 to 6. Accordingly, the descriptions of the first display 130 and the first side member 113 of the first housing 110 may be supplemented or replaced by the descriptions made with reference to FIGS. 1 to 6.

In an embodiment, the first buffer structure 210 may include a first buffer member 710 and a second buffer member 720. The first buffer member 710 may be disposed between at least one side part (e.g., the side part 411e of the polymer layer 411, the side part 412e of the glass layer 412, the side part 420e of the polarizing film 420, the side part 430e of the display panel 430, or side parts P1e and P2e of the adhesive members P1 and P2) of the display 130 and the inner surface 513 of the first side wall 110a of the first side member 113. The second buffer member 720 may be disposed between at least one side part of the display 130 and the first buffer member 710.

In an embodiment, the first buffer member 710 may have a first elasticity that is higher than that of the inner surface 513 of the first side wall 110a. The second buffer member 720 may have a second elasticity that is higher than that of the first buffer member 710. In an embodiment, the first buffer member 710 may have a first modulus, and the second buffer member 720 may have a second modulus that is lower than the first modulus. In an embodiment, the first buffer member 710 may have a first hardness (or rigidity), and the second buffer member 720 may have a second hardness (or rigidity) that is lower than that of the first hardness.

In an embodiment, the first buffer member 710 may include a first buffer part 7101 and a second buffer part 7102. The first buffer part 7101 may be disposed between the second buffer member 720 and the inner surface 513 of the first side wall 110a. The second buffer part 7102 may be disposed between a side part (or a side part of a portion of the display 130 that does not contact the first buffer member 710) (e.g., the side part P2e of the second adhesive member P2 or the side part 430e of the display panel 430) of a portion of the display 130 and an inner surface 513 of the first side wall 110a. The first buffer part 7101 may include a first buffer side surface 711 that faces the second buffer member 720, a second buffer side surface 712 that faces the inner surface 513 of the first side wall 110a, and a first buffer front surface 713 that faces a front surface of the electronic device. The first buffer side surface 711 may be inclined such that, when the electronic device is unfolded (or in an unfolded state), the first buffer side surface 711 becomes closer to the inner surface 513 of the first side wall 110a as it becomes farther away from the second buffer part 7102 (or as it approaches the first buffer front surface 713 from the second buffer part 7102, as it extends from a lower end to an upper end, or as it extends in the z-axis direction). At least a portion of the first buffer side surface may contact the fourth buffer side surface 722 of the second buffer member 720. At least a portion of the second buffer side surface may contact the inner surface 513 of the first side wall 110a. In an embodiment, when the electronic device is unfolded (or in an unfolded state), a portion of the second buffer side surface may contact the inner surface 513 of the first side wall 110a. When the electronic device is unfolded (or in an unfolded state), at least a portion of the remaining part of the second buffer side surface 712 may be inclined such that it becomes closer to the inner surface 513 of the first side wall 110a as it becomes farther away from the second buffer part 7102. A size (or an extent) of the first buffer front surface 713 that is exposed to the outside of the electronic device may be smaller than that of the second buffer front surface 723. In an embodiment, the first buffer front surface 713 may be formed to have a first width L71 (e.g., the y-axis length, a length that is perpendicular to the folding axis, or a slip direction (e.g., a length of a first slip direction S1 in FIG. 4)) that is exposed to the outside of the electronic device.

The second buffer part 7102 may be disposed on the support plate 440 of the display 130. The second buffer part 7102 may include a fifth buffer side surface 715 that faces the display panel 430 and a sixth buffer side surface 716 that faces the inner surface 513 of the first side wall 110a. The second buffer part 7102 may define a step with the first buffer part 7101. The sixth buffer side surface 716 of the second buffer part 7102 may be spaced apart by a designated distance D7 from the inner surface 513 of the first side wall 110a when the electronic device is unfolded (or in an unfolded state). Due to the spacing between the inner surface 513 of the first side wall 110a and the sixth buffer side surface 716, interference between the first housing 110 and the first buffer member 710 may be minimized and/or reduced. Damage to the display 130 due to interference between the first housing 110 and the first buffer member 710 may be minimized and/or reduced.

The second buffer member 720 may include a third buffer side surface 721 that faces the display panel 430, a fourth buffer side surface 722 that faces the first buffer member 710, and a second buffer front surface 723 that faces a front surface of the electronic device. The third buffer side surface 721 may face (or contact or oppose) at least any one of the side part 411e of the polymer layer 411, the side part 412e of the glass layer 412, the side part 420e of the polarizing film 420, and the side part P1e of the first adhesive member P1. The fourth buffer side surface 722 may be inclined such that, when the electronic device is unfolded (or in an unfolded state), the fourth buffer side surface 722 becomes closer to the inner surface 513 of the first side wall 110a as it becomes farther away from the support plate 440 (or as it approaches the second buffer front surface 723, as it extends from a lower end to an upper end, or as it extends in the z-axis direction). At least a portion of the fourth buffer side surface 722 may contact the first buffer side surface 711 of the first buffer member 710 to define a boundary surface 730 when the electronic device is unfolded (or in an unfolded state). The boundary surface 730 may be inclined along the inclined shapes of the fourth buffer side surface and the first buffer side surface such that, as it extends from a lower end to an upper end (or as it extends in the z-axis direction), it becomes closer to the inner surface 513 of the first side wall 110a. When the electronic device is unfolded (or in an unfolded state), a size (or an extent) of the second buffer front surface 723 that is exposed to the outside of the electronic device may be larger than that of the first buffer front surface 713. In an embodiment, the second buffer front surface 723 may be formed to have a second width L72 (e.g., the y-axis length, a length that is perpendicular to the folding axis, or a slip direction (e.g., a length of a first slip direction S1 in FIG. 4)) that is exposed to the outside of the electronic device. The second width L72 may be larger than the first width L71 of the first buffer front surface 713.

The second buffer member 720 may include a second buffer front surface 723 that extends in a slip direction (e.g., the first slip direction S1 in FIG. 4, the y-axis lengthwise direction, or a lengthwise direction that is perpendicular to the folding axis) (or toward the inner surface), so that stress due to slip that occurs during a folding operation of the display 130 may be minimized or reduced.

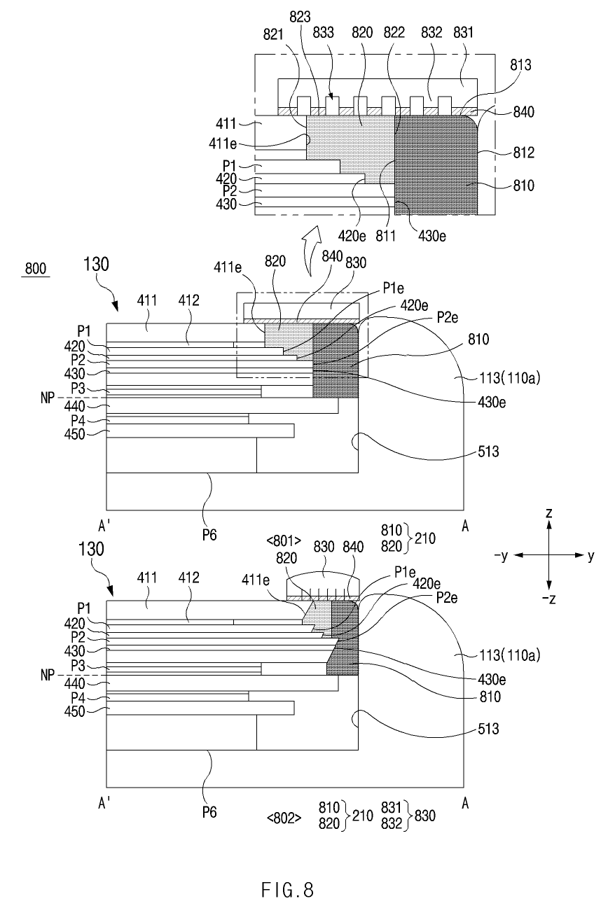

FIG. 8 is a view illustrating embodiments of a portion of a cross section of a foldable electronic device. In an embodiment, in FIG. 8, <801> is a view illustrating an unfolded state of the foldable electronic device, taken along cutting line A-A’ of FIG. 4, and <802> is a view illustrating a folded state of the foldable electronic device, taken along line A-A’ of FIG. 4.

The foldable electronic device 800 of FIG. 8 may be at least partially similar to at least one of the electronic devices of FIGS. 1 to 7, or may include other embodiments of the electronic device. The electronic device of FIG. 8 is identical to at least one of the previous embodiments of FIGS. 1 to 7, or for components that may be easily understood from the previous embodiments, the same reference numerals are assigned or omitted, and detailed descriptions thereof are also omitted.

Referring to FIG. 8, the foldable electronic device 800 may include a first housing 110, a first buffer structure 210, a first display 130, and a film member 830. In the following descriptions, a structure of the first housing 110 and the first buffer structure 210, taken along cutting line A-A’, will be illustrated and described as an example. When cutting line A-A’ is applied to a predetermined position of the second housing (the second housing 120 of FIGS. 1 to 6) and the second buffer structure (the second buffer structure 220 of FIG. 3), at least a portion of cut surfaces of the fifth side wall 120a of a second side member 123 included in the second housing 120 and the second buffer structure 220 may be the same as or similar to cut surfaces of the first side wall 110a of a first side member 113 included in the first housing 110 and the first buffer structure 210.

The first display 130, a first side member 113 of the first housing 110, and a first buffer structure 210 may include the same or similar components as the first display 130, the first side member 113 of the first housing 110, and the first buffer structure 210 described with reference to FIGS. 1 to 6. Accordingly, the descriptions of the first display 130, the first side member 113 of the first housing 110, and the first buffer structure 210 may be supplemented or replaced by the descriptions made with reference to FIGS. 1 to 6.

In an embodiment, the first buffer structure 210 may include a first buffer member 810 and a second buffer member 820. The first buffer member 810 may be disposed between at least one side part (e.g., the side part 411e of the polymer layer 411, the side part 412e of the glass layer 412, the side part 420e of the polarizing film 420, the side part 430e of the display panel 430, or side parts P1e and P2e of the adhesive members P1 and P2) of the display 130 and the inner surface 513 of the first side wall 110a of the first side member 113. The first buffer member 810 may include a first buffer side surface 811 that contacts a fourth buffer side surface 822 of the second buffer member 820, a second buffer side surface 812 that contacts an inner surface 513 of the first side wall 110a, and a first buffer front surface 813 that connects the first buffer side surface 811 and the second buffer side surface 812. The second buffer member 820 may be disposed between at least one side part of the display 130 and the first buffer member 710. The second buffer member 820 may include a third buffer side surface 821 that contacts at least any one of side parts of the display 130, a fourth buffer side surface 822 that contacts the first buffer side surface 811 of the first buffer member 810, and a second buffer front surface 823 that connects the third buffer side surface 821 and the fourth buffer side surface 822.

In an embodiment, the first buffer member 810 may have a first elasticity that is higher than that of the inner surface 513 of the first side wall 110a. The second buffer member 820 may have a second elasticity that is higher than that of the first buffer member 810. In an embodiment, the first buffer member 810 may have a first modulus, and the second buffer member 820 may have a second modulus that is lower than the first modulus. In an embodiment, the first buffer member 810 may have a first hardness (or rigidity), and the second buffer member 820 may have a second hardness (or rigidity) that is lower than that of the first hardness.

In an embodiment, the film member 830 may be formed along the first buffer structure 210 over the first buffer structure 210. In an embodiment, the film member 830 may form a C shape or a partial band shape (or an angled shape, or a curved shape), one side of which is opened toward the -y-axis. The film member 830 may be disposed over at least any one of the first buffer member 810 and the second buffer member 820. In an embodiment, the film member 830 may be attached to at least any one of the first buffer front surface 813 of the first buffer member 810 and the second buffer front surface 823 of the second buffer member 820 through an adhesive member 840. In an embodiment, the film member 830 may be attached to at least any one of a front portion of a polymer layer 411 of the display 130, the first buffer front surface 813 of the first buffer member 810, and the second buffer front surface 823 of the second buffer member 820 through the adhesive member 840. The film member 830 may prevent the first buffer member 810 and the second buffer member 820 from being exposed to the outside of the electronic device, so that the first buffer member 810 and the second buffer member 820 may be protected. In an embodiment, the film member 830 may prevent the first buffer member 810 and the second buffer member 820 from being peeled off or damaged by an external force.

In an embodiment, the film member 830 may include a first film part 831 and a plurality of second film parts 832. At least any one of the plurality of second film parts 832 may protrude (or extend) from the first film part 831 toward the first buffer member 810 and the second buffer member 820. When the electronic device is unfolded (or in an unfolded state), the plurality of second film parts 832 may be spaced apart from each other with a slit space 833 interposed therebetween. The plurality of second film parts 832 may be compressed in the same direction (e.g., a first slip direction (the first slip direction S1 in FIG. 4), a direction that is perpendicular to the folding axis, or the y-axis direction) as that of the first buffer structure 210 during folding of the electronic device (or the display or the folding housing). The slit space 833 may be reduced by the plurality of second film parts 832 that is compressed, so that the plurality of second film parts 832 may become closer to each other. In an embodiment, the plurality of second film parts 832 may be closely attached to each other without the slit space 833.

In an embodiment, the film member 830 and the adhesive member 840 may be formed to have a thickness (or the z-axis length) that is relatively small enough to prevent a user’s hand from catching during use of the electronic device. In an embodiment, a sum of a thickness of the film member 830 and a thickness of the adhesive member 840 may be 0.05 mm or more and 0.2 mm or less.

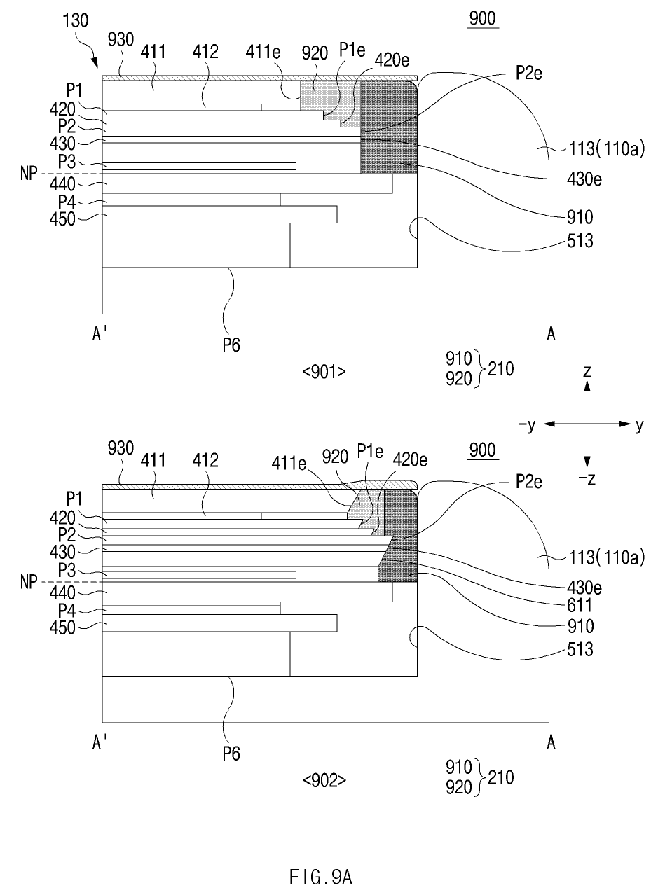

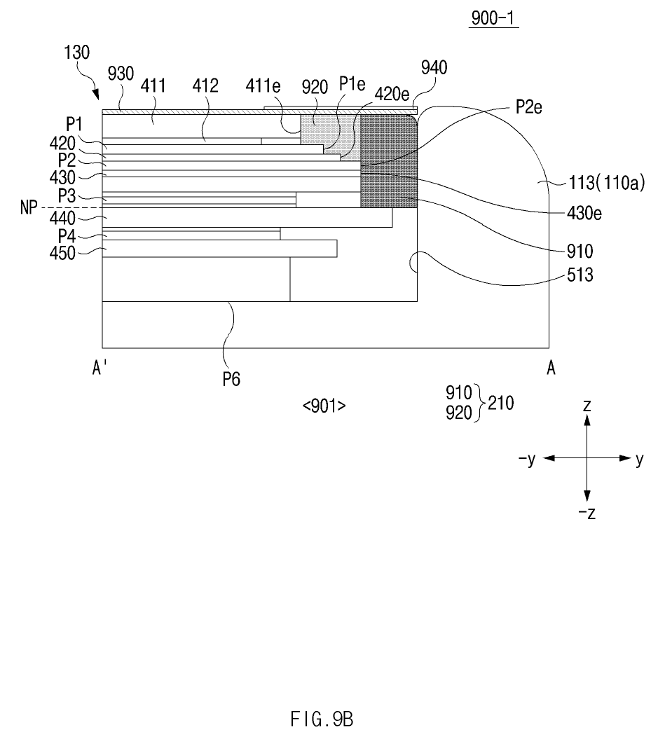

FIGS. 9A and 9B are views illustrating embodiments of a portion of a cross section of a foldable electronic device. In an embodiment, In FIG. 9A, <901> is a view illustrating an unfolded state of the foldable electronic device, taken along cutting line A-A’ of FIG. 4, and <902> is a view illustrating a folded state of the foldable electronic device, taken along line A-A’ of FIG. 4. FIG. 9B is a view illustrating an unfolded state of the foldable electronic device, taken along cutting line A-A’ of FIG. 4.

The foldable electronic device 900 of FIG. 9A and the foldable electronic device 900-1 of FIG. 9B may be at least partially similar to at least one of the electronic devices of FIGS. 1 to 6, or may include other embodiments of the electronic device. The foldable electronic device 900 of FIG. 9A and the foldable electronic device 900-1 of FIG. 9B are identical to at least one of the previous embodiments of FIGS. 1 to 6, or for components that may be easily understood from the previous embodiments, the same reference numerals are assigned or omitted, and detailed descriptions thereof are also omitted.

Referring to FIGS. 9A and 9B, the foldable electronic devices 900 and 900-1 may include a first housing 110, a first buffer structure 210, a first display 130, and a coating layer 930 (or a hard coating layer). In the following descriptions, a structure of the first housing 110 and the first buffer structure 210, taken along cutting line A-A’, will be illustrated and described as an example. When cutting line A-A’ is applied to a predetermined position of the second housing (the second housing 120 of FIGS. 1 to 6) and the second buffer structure (the second buffer structure 220 of FIG. 3), at least a portion of cut surfaces of the fifth side wall 120a of a second side member 123 included in the second housing 120 and the second buffer structure 220 may be the same as or similar to cut surfaces of the first side wall 110a of a first side member 113 included in the first housing 110 and the first buffer structure 210.

The first display 130, a first side member 113 of the first housing 110, and a first buffer structure 210 may include the same or similar components as the first display 130, the first side member 113 of the first housing 110, and the first buffer structure 210 described with reference to FIGS. 1 to 6. Accordingly, the descriptions of the first display 130, the first side member 113 of the first housing 110, and the first buffer structure 210 may be supplemented or replaced by the descriptions made with reference to FIGS. 1 to 6.

In an embodiment, the first buffer structure 210 may include a first buffer member 910 and a second buffer member 920. The first buffer member 910 may be disposed between at least one side part (e.g., the side part 411e of the polymer layer 411, the side part 412e of the glass layer 412, the side part 420e of the polarizing film 420, the side part 430e of the display panel 430, or side parts P1e and P2e of the adhesive members P1 and P2) of the display 130 and the inner surface 513 of the first side wall 110a of the first side member 113. The first buffer member 910 may contact at least a portion of the second buffer member 920 and at least a portion of an inner surface 513 of the first side wall 110a. The second buffer member 920 may be disposed between at least one side part of the display 130 and the first buffer member 910. The second buffer member 920 may contact at least one side part of the display 130 and at least a portion of the first buffer member 910.

In an embodiment, the first buffer member 910 may have a first elasticity that is higher than that of the inner surface 513 of the first side wall 110a. The second buffer member 920 may have a second elasticity that is higher than that of the first buffer member 810. In an embodiment, the first buffer member 910 may have a first modulus, and the second buffer member 920 may have a second modulus that is lower than the first modulus. In an embodiment, the first buffer member 910 may have a first hardness (or rigidity), and the second buffer member 920 may have a second hardness (or rigidity) that is lower than that of the first hardness.

In an embodiment, the coating layer 930 may be disposed on at least any one of an uppermost layer of the display, the first buffer member 810, and the second buffer member 820. In an embodiment, the coating layer 930 may be applied over entire surfaces of each of the polymer layer 411, the first buffer member 810, and the second buffer member 820. The coating layer 930 may contact each of the polymer layer 411, the first buffer member 810, and the second buffer member 820. The coating layer 930 may be formed to cross the folding axis, and thus may be formed to have a thickness that may withstand folding of the display. In an embodiment, the coating layer 930 may be formed to have a thickness (e.g., the z-axis length) of 20 micrometers (µm) or more and 30 µm or less. The coating layer 930 may prevent the first buffer member 810 and the second buffer member 820 from being exposed to the outside of the electronic device, so that the first buffer member 810 and the second buffer member 820 may be protected. In an embodiment, the coating layer 930 may prevent the first buffer member 810 and the second buffer member 820 from being peeled off or damaged by an external force.

In an embodiment, the foldable electronic device 900-1 may include a printing layer 940 (or an opaque layer) that is disposed on the coating layer 930, as illustrated in FIG. 9B. The printing layer 940 may be printed on the coating layer 930 to be at least partially opaque. The printing layer 940 may be formed on the coating layer 930 to correspond to (or overlap) a front surface (e.g., a surface that faces the z-axis) of the first buffer member 810 and the second buffer member 820. The printing layer 940 may include or consist of black resin.

In an embodiment, the coating layer 930 of the foldable electronic device may be formed to contact the polymer layer 411 in an area corresponding to the display 130, and the printing layer 940 may be formed to contact the first buffer member 810 and the second buffer member 820 in an area corresponding to the first buffer member 810 and the second buffer member 820.

In an embodiment, the coating layer 930 may be formed to have a uniform thickness when the electronic device is unfolded (or in an unfolded state). The coating layer 930 may be compressed in the same direction (e.g., a first slip direction (the first slip direction S1 in FIG. 4), a direction that is perpendicular to the folding axis, or the y-axis direction) as that of the first buffer structure 210 during folding of the electronic device (or the display or the folding housing).

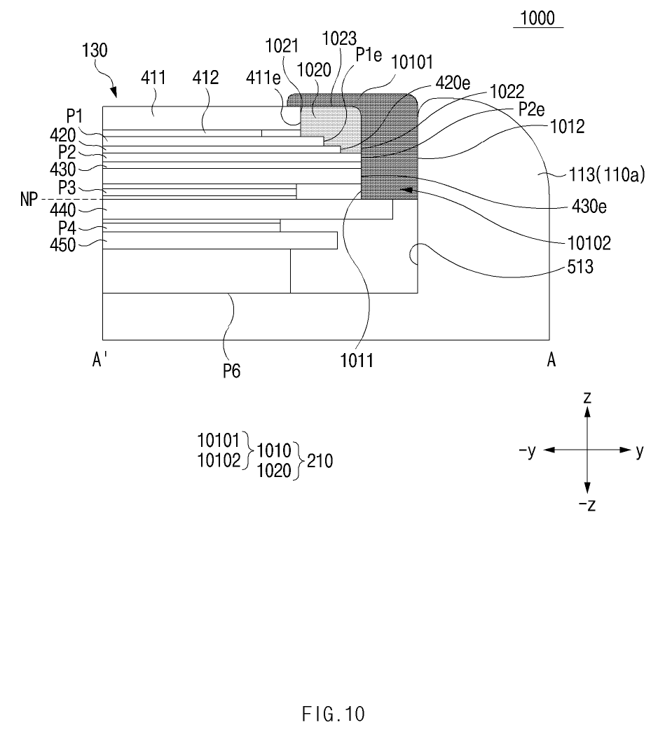

FIG. 10 is a view illustrating an embodiment of a portion of a cross section of a foldable electronic device. In an embodiment, FIG. 10 is a view illustrating an unfolded state of the foldable electronic device, taken along cutting line A-A’ of FIG. 4 above.

The foldable electronic device 1000 of FIG. 10 may be at least partially similar to at least one of the electronic devices of FIGS. 1 to 7, or may include other embodiments of the electronic device. The electronic device of FIG. 10 is identical to at least one of the previous embodiments of FIGS. 1 to 9, or for components that may be easily understood from the previous embodiments, the same reference numerals are assigned or omitted, and detailed descriptions thereof are also omitted.

Referring to FIG. 10, the foldable electronic device 1000 may include a first housing 110, a first buffer structure 210, a first display 130, and a film member 830. In the following descriptions, a structure of the first housing 110 and the first buffer structure 210, taken along cutting line A-A’, will be illustrated and described as an example. When cutting line A-A’ is applied to a predetermined position of the second housing (the second housing 120 of FIGS. 1 to 6) and the second buffer structure (the second buffer structure 220 of FIG. 3), at least a portion of cut surfaces of the fifth side wall 120a of a second side member 123 included in the second housing 120 and the second buffer structure 220 may be the same as or similar to cut surfaces of the first side wall 110a of a first side member 113 included in the first housing 110 and the first buffer structure 210.

The first display 130, a first side member 113 of the first housing 110, and a first buffer structure 210 may include the same or similar components as the first display 130, the first side member 113 of the first housing 110, and the first buffer structure 210 described with reference to FIGS. 1 to 6. Accordingly, the descriptions of the first display 130, the first side member 113 of the first housing 110, and the first buffer structure 210 may be supplemented or replaced by the descriptions made with reference to FIGS. 1 to 6.

In an embodiment, the first buffer structure 210 may include a first buffer member 1010 and a second buffer member 1020. The first buffer member 1010 may be disposed between at least one side part (e.g., the side part 411e of the polymer layer 411, the side part 412e of the glass layer 412, the side part 420e of the polarizing film 420, the side part 430e of the display panel 430, or side parts P1e and P2e of the adhesive members P1 and P2) of the display 130 and the inner surface 513 of the first side wall 110a of the first side member 113. The first buffer member 1010 may contact at least a portion of the second buffer member 1020 and at least a portion of an inner surface 513 of the first side wall 110a. The second buffer member 1020 may be disposed between at least one side part of the display 130 and the first buffer member 1010. The second buffer member 1020 may contact at least one side part of the display 130 and at least a portion of the first buffer member 1010.

In an embodiment, the first buffer member 1010 may have a first elasticity that is higher than that of the inner surface 513 of the first side wall 110a. The second buffer member 1020 may have a second elasticity that is higher than that of the first buffer member 1010. In an embodiment, the first buffer member 1010 may have a first modulus, and the second buffer member 1020 may have a second modulus that is lower than the first modulus. In an embodiment, the first buffer member 1010 may have a first hardness (or rigidity), and the second buffer member 1020 may have a second hardness (or rigidity) that is lower than that of the first hardness.

In an embodiment, the first buffer member 1010 may extend between the second buffer member 1020 and an inner surface 513 of the first side wall 110a and may be disposed on at least a portion of the second buffer member 1020. The first buffer member 1010 may be formed to cover (or overlap) at least a portion of the second buffer member 1020. In an embodiment, the first buffer member 1010 may be formed in an inverted “L” shape.

In an embodiment, the first buffer member 1010 may include a first buffer part (or an upper end) 10101 and a second buffer part (or a lower end) 10102. The first buffer part 10101 may extend from the second buffer part 10102 and may be formed to cover at least a portion of the second buffer member 1020. A portion of the first buffer part 10101 may be disposed on the second buffer front surface 1023 of the second buffer member 1020. A portion of the first buffer part 10101 may contact the second buffer front surface 1023 of the second buffer member 1020. The second buffer part 10102 may be disposed between the second buffer member 1020 and the inner surface 513 of the first side wall 110a. The second buffer part 10102 may include a first buffer side surface 1011 that faces the second buffer member 1020 and a second buffer side surface 1012 that faces an inner surface 513 of the first side wall 110a. A portion of the first buffer side surface 1011 may contact the fourth buffer side surface 1022 of the second buffer member 1020, and a remaining portion of the first buffer side surface 1011 may contact a side part (or a side part of a portion of the display that does not contact the first buffer member 1010) (e.g., a side part P2e of the second adhesive member P2 or a side part 430e of the display panel 430) of a portion of the display 130. The first buffer member 1010 may be formed to cover the second buffer member 1020, so that the first buffer member 1010 that has a rigidity (or a modulus) that is higher than that of the second buffer member 1020 may be exposed to the outside of the electronic device. The second buffer member 1020 that has a relatively lower rigidity may be protected from disturbances (e.g., external impacts) by the first buffer member 1010 that is exposed to the outside of the electronic device.

In an embodiment, the first buffer member 1010 exposed to the outside of the foldable electronic device 1000 may be formed to have a thickness (or a length in the z-axis direction) such that catching of a user’s hand does not occur during use of the electronic device.

The second buffer member 1020 may include a third buffer side surface 1021 that faces the display 130, a fourth buffer side surface 1022 that faces the first buffer member 1010, and a second buffer front surface 1023 that faces a front surface of the electronic device. The third buffer side surface 1021 may face (or contact or oppose) at least any one of the side part 411e of the polymer layer 411, the side part 412e of the glass layer 412, the side part 420e of the polarizing film 420, and the side part P1e of the first adhesive member P1. At least a portion of the fourth buffer side surface 1022 may contact the first buffer side surface 1012 of the first buffer member 1010 when the electronic device is unfolded (or in an unfolded state). The second buffer member 1020 may absorb slip of the display 130 due to a folding operation of the foldable electronic device 1000, so that stress due to the slip phenomenon of the display 130 may be minimized and/or reduced.

FIG. 11 is a view illustrating embodiments of a portion of a cross section of a foldable electronic device. In an embodiment, In FIG. 11, <1101> is a view illustrating an unfolded state of the foldable electronic device, taken along cutting line B-B’ of FIG. 4, and <1102> is a view illustrating a folded state of the foldable electronic device, taken along line B-B’ of FIG. 4.

The foldable electronic device 1100 of FIG. 11 may be at least partially similar to at least one of the electronic devices of FIGS. 1 to 10, or may include other embodiments of the electronic device. The electronic device of FIG. 11 is identical to at least one of the previous embodiments of FIGS. 1 to 10, or for components that may be easily understood from the previous embodiments, the same reference numerals are assigned or omitted, and detailed descriptions thereof are also omitted.

Referring to FIG. 11, the foldable electronic device 1100 may include the second housing 120, the second buffer structure 220, and the first display 130. In the following descriptions, a structure of the second housing 120 and the second buffer structure 220, taken along cutting line B-B’, will be illustrated and described as an example. When cutting line B-B’ is applied to a predetermined position of the first housing (the first housing 110 of FIGS. 1 to 6) and the first buffer structure (the first buffer structure 210 of FIG. 3), at least a portion of cut surfaces of the first side wall 110a of the first side member 113 included in the first housing 110 and the first buffer structure 210 may be the same as or similar to cut surfaces of the fifth side wall 120a of the second side member 123 included in the second housing 120 and the second buffer structure 220.

The first display 130, the second side member 123 of the second housing 120, and the second buffer structure 220 may include the same or similar components as the first display 130, the second side member 123 of the second housing 120, and the second buffer structure 220 described with reference to FIGS. 1 to 6. Accordingly, the descriptions of the first display 130, the second side member 123 of the second housing 120, and the second buffer structure 220 may be supplemented or replaced by the descriptions made with reference to FIGS. 1 to 6.

In an embodiment, the first display 130 may include a flexible substrate 1150 that includes a bent portion 1151, in which a portion of at least any one of opposite peripheries that are parallel to the folding axis F is bent. The bent portion 1151 of the flexible substrate 1150 may be folded from the display panel 430 toward at least a partial area of a rear surface (e.g., the -z-axis direction) of the display 130. The display circuit unit (not illustrated) may be disposed on the flexible substrate 1150 including the bent portion 1151 in a chip on film (COF) structure or a chip on plastic or chip on panel (COP) structure. The flexible substrate 1150 may be a portion of a plastic substrate or a glass substrate included in the display panel 430. The display circuit unit may include a display driver IC (DDI) and/or a touch display driver IC (TDDI). A bending protection layer 1152 may be formed on the flexible substrate 1150 to be disposed to correspond to the bent portion 1151.

In an embodiment, a second buffer structure 220 (e.g., the second buffer structure 220 of FIG. 3) may include a third buffer member 1110 and a fourth buffer member 1120. The third buffer member 1110 may be disposed between at least a portion of the fourth buffer member 1120, a portion (e.g., the flexible substrate 1150 or the bending protection layer 1152) of the display 130, and an inner surface 523 of the fifth side wall 120a of the second side member 123. The third buffer member 1110 may contact at least a portion of the fourth buffer member 1120 and at least a portion of the inner surface 523 of the fifth side wall 120a. The fourth buffer member 1120 may be disposed between at least one side part of the display 130 and the third buffer member 1110. The fourth buffer member 1120 may contact at least one side part of the display 130 (e.g., a polymer layer (e.g., the polymer layer 411 of FIG. 5) and the side part 410e of the window 410 including a glass layer (e.g., the glass layer 412 of FIG. 5), and the side part 420e of the polarizing film 420), and at least a portion of the third buffer member 1110.

In an embodiment, the third buffer member 1110 may have a first elasticity that is higher than that of the fifth side wall 120a (or the inner surface 523 of the fifth side wall 120a). The fourth buffer member 1120 may have a second elasticity that is higher than that of the third buffer member 1110. In an embodiment, the third buffer member 1110 may have a first modulus, and the fourth buffer member 1120 may have a second modulus that is lower than the first modulus. In an embodiment, the third buffer member 1110 may have a first hardness (or rigidity), and the fourth buffer member 1120 may have a second hardness (or rigidity) that is lower than that of the first hardness. The third buffer member 1110 that a lower elasticity but higher hardness and modulus than those the fourth buffer member 1120 may protect the display 130 and prevent the fourth buffer member 1120 from being separated due to an external force. The fourth buffer member 1120 that has a lower elasticity but higher hardness and modulus than those the third buffer member 1110 may maximally absorb a slip of the display 130 due to a folding operation of the foldable electronic device 1100.

In an embodiment, a portion of the third buffer member 1110 may be formed to have a curved surface along the bent portion 1151 of the flexible substrate 1150. The third buffer member 1110 may include a first buffer side surface (e.g., a surface that faces the y axis) 1111 that faces the fourth buffer member 1120, a second buffer side surface (e.g., a surface that faces the -y axis) 1112 that faces an inner surface 523 of the fifth side wall 120a, and a third buffer side surface 1113 that faces the bent portion 1151. The third buffer side surface 1113 may be formed in a curved shape along a bent portion 1151 of the flexible substrate 1150. The third buffer side surface 1113 may have the same or a similar curvature (or a radius of curvature) as the bent portion 1151. Due to the third buffer member 1110 having a lower elasticity than that of the fourth buffer member and higher hardness and modulus than those of the fourth buffer member 1120, the curvature of the bent portion 1151 of the flexible substrate 1150 may be maintained constant.

The fourth buffer member 1120 may include a third buffer side surface (e.g., a surface that faces the y axis) 1121 that faces the display 130 and a fourth buffer side surface (e.g., a surface that faces the -y axis) 1122 that faces the first buffer member 1010. The third buffer side surface 1121 may face (or contact, or oppose) the side part 410e of the window 410 and/or the side part 420e of the polarizing film 420. At least a portion of the fourth buffer side surface 1122 may contact the first buffer side surface 1111 of the third buffer member 1110 when the electronic device is unfolded (or in an unfolded state). The fourth buffer member 1120 may absorb slip of the display 130 due to a folding operation of the foldable electronic device 1100, so that stress due to the slip phenomenon of the display 130 may be minimized and/or reduced.

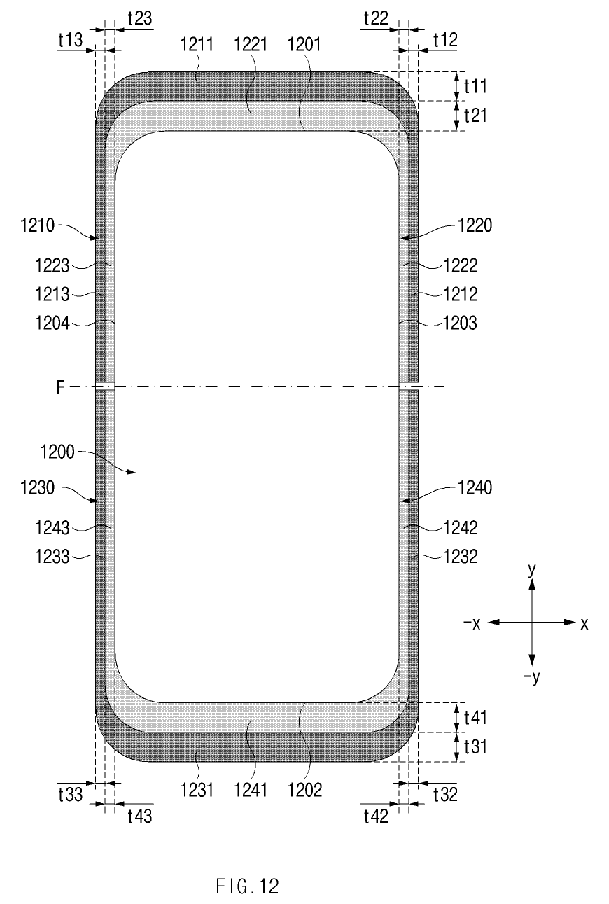

FIG. 12 is a plan view illustrating an embodiment of a foldable electronic device. The foldable electronic device of FIG. 12 may be at least partially similar to at least one of the electronic devices of FIGS. 1 to 11, or may include other embodiments of the electronic device. The electronic device of FIG. 12 is identical to at least one of the previous embodiments of FIGS. 1 to 10, or for components that may be easily understood from the previous embodiments, the same reference numerals are assigned or omitted, and detailed descriptions thereof are also omitted.

Referring to FIG. 12, a foldable electronic device in an embodiment may include a display (e.g., any one of the displays 130 of FIGS. 1 to 11) that includes a plurality of layers, a first buffer member 1210, a second buffer member 1220, a third buffer member 1230, and a fourth buffer member 1240.

In an embodiment, the first buffer member 710 may have a first elasticity that is higher than that of the first side wall (e.g., the first side wall 110a of FIGS. 5 to 10) (or an inner surface (e.g., the first inner surface 513 of FIGS. 5 to 10) of the first side wall). The second buffer member 1220 may have a second elasticity that is higher than that of the first buffer member 1210. The first buffer member 1210 may have a first modulus, and the second buffer member 1220 may have a second modulus that is lower than the first modulus. The first buffer member 1210 may have a first hardness (or rigidity), and the second buffer member 1220 may have a second hardness (or rigidity) that is lower than that of the first hardness. In an embodiment, the third buffer member 1230 may have a third elasticity that is higher than that of a fifth side wall (e.g., the fifth side wall of FIG. 11) (or an inner surface (e.g., the inner surface 523 of FIG. 11 of the fifth side wall), and is the same as or similar to the first elasticity of the first buffer member 1210. The fourth buffer member 1240 may have a fourth elasticity that is higher than that of the third buffer member 1230 and is the same as or similar to a second elasticity of the second buffer member 1220. The third buffer member 1230 may have a third modulus that is the same as or similar to the first modulus of the first buffer member 1210, and the fourth buffer member 1240 may have a fourth modulus that is lower than the third modulus and is the same as or similar to the second modulus of the second buffer member 1220. The third buffer member 1230 may have a third hardness (or rigidity) that is the same as or similar to the first hardness of the first buffer member 1210, and the fourth buffer member 1240 may have a fourth hardness (or rigidity) that is lower than the third hardness and is the same as or similar to the second hardness of the second buffer member 1220.

In an embodiment, the display may include a first layer part (e.g., the first layer part LA1 of FIG. 5), a second layer part (e.g., the second layer part LA2 of FIG. 5) 1200, and a third layer part (e.g., the third layer part LA3 of FIG. 5). The first layer part may be disposed between the second layer part and the third layer part. The second layer part 1200 may be disposed on the first layer part. The third layer part may be disposed under the first layer part.

In an embodiment, the first layer part, the second layer part 1200, and the third layer part may include at least any one layer. In an embodiment, the first layer part may include a display panel. The second layer part 1200 may include at least any one of a plurality of layers that are disposed on the display panel. In an embodiment, the second layer part 1200 may include a polymer layer that is disposed on the display panel to protect the display panel. In an embodiment, the second layer part 1200 may include a polymer layer that is disposed on the display panel to protect the display panel and a glass layer that is disposed between the display panel and the polymer layer. The third layer part may include at least any one of a plurality of layers that are disposed under the display panel.

In an embodiment, the second layer part 1200 (e.g., a display panel (e.g., the display panel 430 of FIGS. 1 to 11), the polymer layer 411 of FIGS. 1 to 11, the glass layer 412 of FIGS. 1 to 11, and/or the polarizing film 420 of FIGS. 1 to 11) may include a first side surface portion 1201, a second side surface portion 1202, a third side surface portion 1203, and a fourth side surface portion 1204. The first side surface portion 1201 and the second side surface portion 1202 may be substantially parallel to the folding axis F and may face each other. The third side surface portion 1203 and the fourth side surface portion 1204 may be substantially perpendicular to the folding axis F and may face each other. The third side surface portion 1203 may be connected to one end (e.g., a periphery that faces the x axis) of the first side surface portion 1201 and one end (e.g., a periphery that faces the x axis) of the second side surface portion 1202, between the first side surface portion 1201 and the second side surface portion 1202. The fourth side surface portion 1204 may be connected to an opposite end (e.g., a periphery that faces the -x axis) of the first side surface portion 1201 and an opposite end (e.g., a periphery that faces the -x axis) of the second side surface portion 1202, between the first side surface portion 1201 and the second side surface portion 1202.

In an embodiment, the first buffer member 1210 may be formed to surround the first side surface portion 1201, a portion (e.g., an upper portion with respect to the folding axis F) of the third side surface portion 1203, and a portion (e.g., an upper portion with respect to the folding axis F) of the fourth side surface portion 1204. The third buffer member 1230 may be formed to surround the second side surface portion 1202, a remaining portion (e.g., a lower portion with respect to the folding axis F) of the third side surface portion 1203, and a remaining portion (e.g., a lower portion with respect to the folding axis F) of the fourth side surface portion 1204. The first buffer member 1210 and the third buffer member 1230 may be substantially symmetrical with respect to the folding axis F. The second buffer member 1220 may be formed along the first buffer member 1210 on an outer side of the first buffer member 1210. The fourth buffer member 1240 may be formed along the third buffer member 1230 on an outer side of the third buffer member 1230.

In an embodiment, the first buffer member 1210 may include an eleventh sub-buffer part 1211 that is formed along the first side surface portion 1201 of the second layer part 1200 of the display, a twelfth sub-buffer part 1212 that extends from one end (e.g., a periphery that faces the x axis) of the eleventh sub-buffer part 1211 toward the folding axis F, and a thirteenth sub-buffer part 1213 that extends from an opposite end (e.g., a periphery that faces the -x axis) of the eleventh sub-buffer part 1211 toward the folding axis F. In an embodiment, the second buffer member 1220 may include a twenty-first sub-buffer part 1221 that is formed along the eleventh sub-buffer part 1211 of the first buffer member 1210, a twenty-second sub-buffer part 1222 that extends from one end (e.g., a periphery that faces the x axis) of the twenty-first sub-buffer part 1221 toward the folding axis F, and a twenty-third sub-buffer part 1223 that extends from an opposite end (e.g., a periphery that faces the -x axis) of the twenty-first sub-buffer part 1221 toward the folding axis F. In an embodiment, the third buffer member 1230 may include a thirty-first sub-buffer part 1231 that is formed along the second side surface portion 1202 of the second layer part 1200 of the display, a thirty-second sub-buffer part 1232 that extends from one end (e.g., a periphery that faces the x axis) of the thirty-first sub-buffer part 1231 toward the folding axis F, and a thirty-third sub-buffer part 1233 that extends from an opposite end (e.g., a periphery that faces the -x axis) of the thirty-first sub-buffer part 1231 toward the folding axis F. In an embodiment, the fourth buffer member 1240 may include a forty-first sub-buffer part 1241 that is formed along the thirty-first sub-buffer part 1231 of the third buffer member 1230, a forty-second sub-buffer part 1242 that extends from one end (e.g., a periphery that faces the x axis) of the forty-first sub-buffer part 1241 toward the folding axis F, and a forty-third sub-buffer part 1243 that extends from an opposite end (e.g., a periphery that faces the -x axis) of the forty-first sub-buffer part 1241 toward the folding axis F.

In an embodiment, at least one layer (e.g., the second layer part 1200) included in the display may experience a slip phenomenon in a direction that is perpendicular to the folding axis F (or the y-axis direction) rather than in a direction that is parallel to the folding axis F (or the x-axis direction). Considering a slip amount of the display caused by a folding operation of the display, at least one sub-buffer part (e.g., the eleventh sub-buffer part 1211, the twenty-first sub-buffer part 1221, the thirty-first sub-buffer part 1231, or the forty-first sub-buffer part 1241) that is disposed parallel to the folding axis F may be formed to have a larger size than at least any one of the remaining buffer parts (e.g., the twelfth sub-buffer part 1212, the thirteenth sub-buffer part 1213, the twenty-second sub-buffer part 1222, the twenty-third sub-buffer part 1223, the thirty-second sub-buffer part 1232, the thirty-third sub-buffer part 1233, the forty-second sub-buffer part 1242, or the forty-third sub-buffer part 1243) that are disposed perpendicular to the folding axis F. At least one sub-buffer part corresponding to the first side surface portion 1201 and the second side surface portion 1202, at which a relatively large slip amount occurs, may be formed to have a larger size than at least one sub-buffer part corresponding to the third side surface portion 1203 and the fourth side surface portion 1204, at which a relatively small slip amount occurs.

In an embodiment, considering a slip amount of the display due to a folding operation of the display, a width (e.g., a length in the y-axis direction) of at least one sub-buffer part that is formed parallel to the folding axis F may be larger than a width (e.g., a length in the x-axis direction) of the remaining buffer parts that are formed perpendicular to the folding axis F. In an embodiment, a width t11 of the eleventh sub-buffer part 1211 may be larger (or wider) than a width t12 (e.g., a length in the x-axis direction) of the twelfth sub-buffer part 1212 and/or a width t13 (e.g., a length in the x-axis direction) of the thirteenth sub-buffer part 1213. In an embodiment, a width t21 (e.g., a length in the y-axis direction) of the twenty-first sub-buffer part 1221 may be larger (or wider) than a width t22 (e.g., a length in the x-axis direction) of the twenty-second sub-buffer part 1222 and/or a width t23 (e.g., a length in the x-axis direction) of the twenty-third sub-buffer part 1223. In an embodiment, a width (e.g., a length in the y-axis direction) t31 of the thirty-first sub-buffer part 1231 may be larger (or wider) than a width t32 (e.g., a length in the x-axis direction) of the thirty-second sub-buffer part 1232 and/or a width t33 (e.g., a length in the x-axis direction) of the thirty-third sub-buffer part 1233. In an embodiment, a width (e.g., a length in the y-axis direction) t41 of the forty-first sub-buffer part 1241 may be larger (or wider) than a width t42 (e.g., a length in the x-axis direction) of the forty-second sub-buffer part 1242 and/or a width t43 (e.g., a length in the x-axis direction) of the forty-third sub-buffer part 1243.

In an embodiment, the first buffer member 1210 and the third buffer member 1230 may protect the display and prevent the second buffer member 1220 and the fourth buffer member 1240 from being separated due to an external force. The second buffer member 1220 and/or the fourth buffer member 1240 may absorb slips of the display in the x-axis direction, the -x-axis direction, the y-axis direction, and the -y-axis direction due to a folding operation of the foldable electronic device 1100.

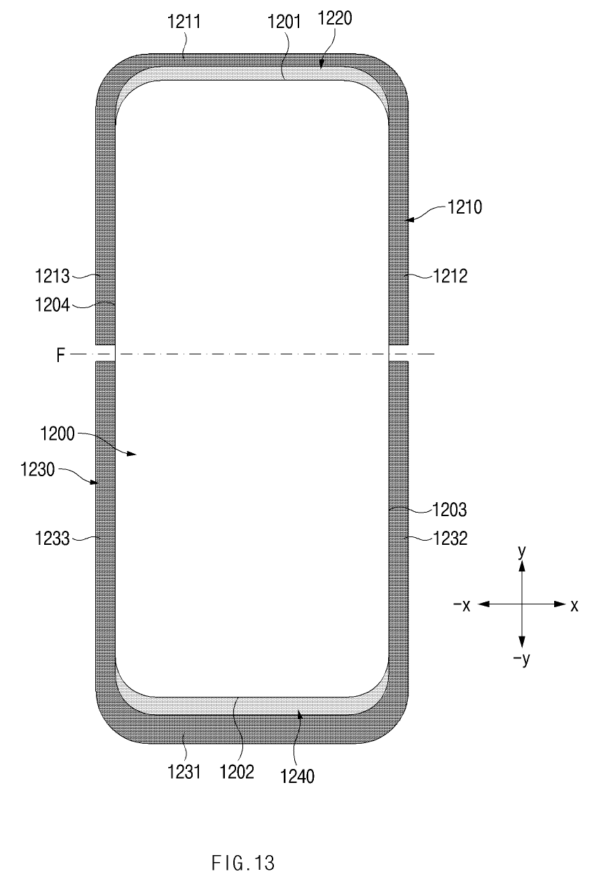

FIG. 13 is a plan view illustrating an embodiment of a foldable electronic device. The foldable electronic device of FIG. 13 may be at least partially similar to at least one of the electronic devices of FIGS. 1 to 12, or may include other embodiments of the electronic device. The electronic device of FIG. 13 is identical to at least one of the previous embodiments of FIGS. 1 to 12, or for components that may be easily understood from the previous embodiments, the same reference numerals are assigned or omitted, and detailed descriptions thereof are also omitted.

Referring to FIG. 13, a foldable electronic device in an embodiment may include a display (e.g., any one of the displays 130 of FIGS. 1 to 11) that includes a plurality of layers, a first buffer member 1210, a second buffer member 1220, a third buffer member 1230, and a fourth buffer member 1240.

In an embodiment, the second layer part 1200 (e.g., a display panel (e.g., the display panel 430 of FIGS. 1 to 11), the polymer layer 411 of FIGS. 1 to 11, the glass layer 412 of FIGS. 1 to 11, and/or the polarizing film 420 of FIGS. 1 to 11) of the display may include a first side surface portion 1201, a second side surface portion 1202, a third side surface portion 1203, and a fourth side surface portion 1204. The first side surface portion 1201 and the second side surface portion 1202 may be substantially parallel to the folding axis F and may face each other. The third side surface portion 1203 and the fourth side surface portion 1204 may be substantially perpendicular to the folding axis F and may face each other. The third side surface portion 1203 may be connected between the first side surface portion 1201 and the second side surface portion 1202 to one end (e.g., a periphery that faces the x axis) of the first side surface portion 1201 and one end (e.g., a periphery that faces the x axis) of the second side surface portion 1202. The fourth side surface portion 1204 may be connected to an opposite end (e.g., a periphery that faces the -x axis) of the first side surface portion 1201 and an opposite end (e.g., a periphery that faces the -x axis) of the second side surface portion 1202, between the first side surface portion 1201 and the second side surface portion 1202.

In an embodiment, the first buffer member 1210 may be formed to surround the first side surface portion 1201, a portion (e.g., an upper portion with respect to the folding axis F) of the third side surface portion 1203, and a portion (e.g., an upper portion with respect to the folding axis F) of the fourth side surface portion 1204. The third buffer member 1230 may be formed to surround the second side surface portion 1202, a remaining portion (e.g., a lower portion with respect to the folding axis F) of the third side surface portion 1203, and a remaining portion (e.g., a lower portion with respect to the folding axis F) of the fourth side surface portion 1204. The first buffer member 1210 and the third buffer member 1230 may be substantially symmetrical with respect to the folding axis F. The second buffer member 1220 may be formed along a portion of the first buffer member 1210. The fourth buffer member 1240 may be formed along a portion of the third buffer member 1230.

In an embodiment, the first buffer member 1210 may include an eleventh sub-buffer part 1211 that is formed along the first side surface portion 1201 of the second layer part 1200 of the display, a twelfth sub-buffer part 1212 that extends from one end (e.g., a periphery that faces the x axis) of the eleventh sub-buffer part 1211 toward the folding axis F, and a thirteenth sub-buffer part 1213 that extends from an opposite end (e.g., a periphery that faces the -x axis) of the eleventh sub-buffer part 1211 toward the folding axis F. The second buffer member 1220 may be formed along the eleventh sub-buffer part 1211 of the first buffer member 1210.

In an embodiment, the third buffer member 1230 may include a thirty-first sub-buffer part 1231 that is formed along the second side surface portion 1202 of the second layer part 1200 of the display, a thirty-second sub-buffer part 1232 that extends from one end (e.g., a periphery that faces the x axis) of the thirty-first sub-buffer part 1231 toward the folding axis F, and a thirty-third sub-buffer part 1233 that extends from an opposite end (e.g., a periphery that faces the -x axis) of the thirty-first sub-buffer part 1231 toward the folding axis F. The fourth buffer member 1240 may be formed along the thirty-first sub-buffer part 1231 of the third buffer member 1230.

In an embodiment, a width (e.g., a length in the y-axis direction) of the eleventh sub-buffer part 1211 of the first buffer member 1210 may be similar to or the same as a width (e.g., a length in the y-axis direction) of the thirty-first sub-buffer part 1231 of the third buffer member 1230. A width (e.g., a length in the x-axis direction) of the twelfth sub-buffer part 1212 of the first buffer member 1210 may be similar to or the same as a width (e.g., a length in the x-axis direction) of the thirty-second sub-buffer part 1232 of the third buffer member 1230. A width (e.g., a length in the x-axis direction) of the thirteenth sub-buffer part 1213 of the first buffer member 1210 may be similar to or the same as a width (e.g., a length in the x-axis direction) of the thirty-third sub-buffer part 1233 of the third buffer member 1230. The widths of the first buffer member 1210 and the third buffer member 1230 are not limited thereto. In an embodiment, when a slip amount of the display in the y-axis direction and a slip amount of the display in the -y-axis direction are different, the first buffer member and the third buffer member may have two or more different widths.

In an embodiment, considering a slip amount of the display due to a folding operation of the display, the second buffer member and the fourth buffer member may be disposed parallel to the folding axis F.

In an embodiment, the eleventh sub-buffer part 1211 of the first buffer member 1210 and the second buffer member 1220 may be disposed to correspond to the first side surface portion 1201, at which a relatively large slip amount occurs (or may be formed along the first side surface portion 1201). The thirty-first sub-buffer part 1231 of the third buffer member 1230 and the fourth buffer member 1240 may be disposed to correspond to the second side surface portion 1202, at which a relatively large slip amount occurs.

In an embodiment, the twelfth sub-buffer part 1212 of the first buffer member 1210 and the thirty-second sub-buffer part 1232 of the third buffer member 1230 may be disposed to correspond to the third side surface portion 1203, at which a relatively small slip amount occurs. The thirteenth sub-buffer part 1213 of the first buffer member and the thirty-third sub-buffer part 1233 of the third buffer member may be disposed to correspond to the third side surface portion 1203, at which a relatively small slip amount occurs.

In an embodiment, the second buffer member 1220 may be formed along the first side surface portion 1201, and may not be formed along the second side surface portion 1202 and/or the third side surface portion 1203. The fourth buffer member 1240 may be formed along the second side surface portion 1202, and may not be formed along the third side surface portion 1203 and/or the fourth side surface portion 1204.

In an embodiment, the first buffer member 1210 and the third buffer member 1230 may protect the display and prevent the second buffer member 1220 and the fourth buffer member 1240 from being separated due to an external force. The second buffer member 1220 and/or the fourth buffer member 1240 may absorb slips of the display in the y-axis direction and the -y-axis direction due to a folding operation of the foldable electronic device 1100.

As described above, the foldable electronic device in an embodiment of the disclosure may minimize display stress due to slip of the display during a folding operation of the foldable electronic device (or the display or the foldable housing) and may secure robustness of the buffer structure against external forces.

A foldable electronic device described in at least an embodiment of the various embodiment described above may include a foldable housing 101, a flexible display 130 disposed inside the foldable housing, configured to be folded or unfolded with respect to a folding axis of the foldable housing, and including a first layer part LA1 and a second layer part LA2 disposed over the first layer part, a first buffer member 610, 710, 810, 910, 1010, and 1210 disposed between a side part of the flexible display and an inner surface 513 of the foldable housing, and having a first elasticity being higher than that of the inner surface, and a second buffer member 620, 720, 820, 920, 1020, and 1220 disposed between the side part of the flexible display and the first buffer member, and having a second elasticity being higher than that of the first buffer member.

In an embodiment, the first buffer member 610, 710, 810, 910, 1010, and 1210 may have a first modulus, and the second buffer member 620, 720, 820, 920, 1020, and 1220 may have a second modulus being lower than the first modulus.

In an embodiment, the first buffer member 610, 710, 810, 910, 1010, and 1210 may have a first hardness, and the second buffer member 620, 720, 820, 920, 1020, and 1220 may have a second hardness being lower than the first hardness.

In an embodiment, the first layer part LA1 has a first length, and the second layer part LA2 has a second length being smaller than the first length.

In an embodiment, when the flexible display 130 is unfolded, a first side part of the first layer part LA1 may protrude further toward the inner surface 513 than a second side part of the second layer part LA2.

In an embodiment, one surface of the second buffer member 620 may not contact a first side part of the first layer part LA1, and may contact a second side part of the second layer part LA2.

In an embodiment, the flexible display 130 may include a display panel 430 included in the first layer part LA1, and a polymer layer 411 disposed over the display panel 430 and included in the second layer part LA2.

In an embodiment, the flexible display 130 may further include a glass layer 412 disposed between the display panel 430 and the polymer layer 411 and included in the second layer part LA2, and a polarizing film 420 disposed between the display panel and the glass layer 412 and included in the second layer part LA2.

When the flexible display 130 is unfolded, a side part 411e and 420e of at least any one of the glass layer 412 and the polarizing film 420 may protrude further toward the inner surface 513 than a side part 411e of the polymer layer.

In an embodiment, the first buffer member 610 may contact a first side part of the first layer part LA1 and the inner surface 513.

In an embodiment, the first buffer member 610 may contact a first side part of the first layer part LA1 and may be at least partially spaced apart from the inner surface 513;

In an embodiment, the second buffer member 620 may contact the first buffer member 610.

In an embodiment, the second layer part LA2 and 1200 may include a first side surface portion 1201 being substantially parallel to the folding axis, a second side surface portion 1202 facing the first side part and being substantially parallel to the folding axis, a third side surface portion 1203 being substantially perpendicular to the folding axis, and a fourth side surface portion 1204 facing the third side surface portion and being substantially perpendicular to the folding axis.

In an embodiment, the second buffer member 1220 may be formed along the first side surface portion 1201.

In an embodiment, the second buffer member 1220 may at least partially extend along at least any one of the third side surface portion 1203 and the fourth side surface portion 1204.

In an embodiment, the first buffer member 1210 may be formed along the first side surface portion 1201, the third side surface portion 1203, and the fourth side surface portion 1204.

In an embodiment, the second buffer member 1220 may be formed along the first side surface portion 1201 and may not be formed along the third side surface portion 1203 and the fourth side surface portion 1204.

In an embodiment, when the flexible display 130 is unfolded, a boundary surface 730 between the first buffer member 710 and the second buffer member 720 may be inclined to be closer to the inner surface 513 from a rear surface toward a front surface of the electronic device.

In an embodiment, the first buffer member 710 may include a first buffer part 7101 disposed between the second buffer member 720 and the inner surface 513 and at least partially contacting the inner surface 513, and a second buffer part 7102 disposed between the second layer part and the inner surface 513 and at least partially spaced apart from the inner surface 513.

In an embodiment, the foldable electronic device may further include a film member 830 disposed over the first buffer member 810 and the second buffer member 820.

In an embodiment, the foldable electronic device may further include a coating layer 930 formed on one surface of the display 130, an upper surface of the first buffer member 810, and an upper surface of the second buffer member 820.

In an embodiment, a printing layer 940 of the coating layer 930, corresponding to the first buffer member 910 and the second buffer member 920, may be at least partially opaque.

In an embodiment, an upper end 10101 of the first buffer member 1010 may extend between the second buffer member 1020 and the inner surface and is formed to cover at least a portion of the second buffer member 1020;

In an embodiment, the foldable electronic device may further include a third buffer member 630 and 1230 being substantially symmetrical to the first buffer member 610 and 1210 with respect to the folding axis F and having a third elasticity being higher than that of the inner surface, and a fourth buffer member 640 and 1240 being substantially symmetrical to the second buffer member 620 and 1220 with respect to the folding axis F and having a fourth elasticity being higher than that of the third buffer member.

In an embodiment, the fourth buffer member 1240 may be formed along the second side surface portion 1202.

In an embodiment, the third buffer member 1230 may be formed along at least a portion of the second side surface portion 1202, a portion of the third side surface portion 1203, and a portion of the fourth side surface portion 1204.

The embodiments of the disclosure and terms used herein are not intended to limit the technologies described in the disclosure to illustrative embodiments, and it should be understood that the embodiments and the terms include modifications, equivalents, and/or alternatives to the corresponding embodiments described herein. With regard to the description of drawings, similar components may be marked by similar reference marks/numerals. The terms of a singular form may include plural forms unless otherwise specified. In the disclosure disclosed herein, the expressions “A or B”, “at least one of A and/or B”, “A, B, or C”, or “at least one of A, B, and/or C”, or the like used herein may include any and all combinations of one or more of the associated listed items. Expressions such as “first,” or “second,” or the like, may express their components regardless of their priority or importance and may be used to distinguish one component from another component but is not limited to these components. When a certain component (e.g., a first component) is referred to as being “connected” or “coupled” (functionally or communicatively) to another component (e.g., a second component), it should be understood that the certain component may be directly connected to the other component or may be connected to the other component through another component (e.g., a third component).

In the disclosure, the expression “adapted to or configured to” used herein may be interchangeably used as the expression “suitable for”, “having the capacity to”, “changed to”, “made to”, “capable of” or “designed to”, for example. The expression “a device configured to” may mean that the device is “capable of” operating together with another device or other parts.

Each element (e.g., a module or a program module) according to various embodiments may consist of single entity or a plurality of entities, a part of the above-described sub-elements may be omitted or may further include other elements. In an alternative embodiment or additionally, some components (e.g., a module or a program module) may be combined with each other so as to form one entity, so that the functions of the components may be performed in the same manner as before the combination. According to various embodiments, operations executed by modules, program modules, or other components may be executed by a successive method, a parallel method, a repeated method, or a heuristic method. In an alternative embodiment, at least some of the operations may be executed in another order or may be omitted, or any other operation may be added.

What is claimed is:

1. A foldable electronic device comprising:
a foldable housing;
a flexible display disposed in the foldable housing and folded or unfolded with respect to a folding axis of the foldable housing, the flexible display including:
a first layer part; and
a second layer part disposed over the first layer part;
a first buffer member disposed between a side portion of the flexible display and an inner surface of the foldable housing, the first buffer member having a first elasticity higher than an elasticity of the inner side in a state in which the first elasticity of the first buffer member and the elasticity of the inner side are measured at a same environmental condition; and
a second buffer member disposed between the side portion of the flexible display and the first buffer member, the second buffer member having a second elasticity higher than the first elasticity of the first buffer member in a state in which the second elasticity of the second buffer member and the first elasticity of the first buffer member are measured at the same environmental condition.

2. The foldable electronic device of claim 1, wherein the first buffer member has a first modulus at the same environmental condition, and
wherein the second buffer member has a second modulus lower than the first modulus at the same environmental condition.

3. The foldable electronic device of claim 1, wherein the first buffer member has a first hardness, and
wherein the second buffer member has a second hardness lower than the first hardness.

4. The foldable electronic device of claim 1, wherein when the flexible display is folded, the first layer part has a first length, and the second layer part has a second length shorter than the first length.

5. The foldable electronic device of claim 1, wherein when the flexible display is folded, a first side part of the first layer part protrudes toward the inner surface than a second side part of the second layer part.

6. The foldable electronic device of claim 1, wherein the second buffer member includes a side non-contacting a first side part of the first layer part and contacting a second side part of the second layer part.

7. The foldable electronic device of claim 1, wherein the flexible display includes:
a display panel included in the first layer part; and
a polymer layer disposed over the display panel and included in the second layer part.

8. The foldable electronic device of claim 7, wherein the flexible display further includes:
a glass layer disposed between the display panel and the polymer layer and included in the second layer part; and
a polarizing film disposed between the display panel and the glass layer and included in the second layer part,
wherein when the flexible display is unfolded, at least one side portion of the glass layer and the polarizing film protrudes toward the inner surface than the side portion of the polymer layer.

9. The foldable electronic device of claim 1, wherein the first buffer member contacts a first side part of the first layer part and the inner surface.

10. The foldable electronic device of claim 1, wherein the first buffer member contacts a first side part of the first layer part and is at least partially spaced from the inner surface.

11. The foldable electronic device of claim 1, wherein the second buffer member contacts the first buffer member.

12. The foldable electronic device of claim 1, wherein the second side of the second layer part includes:
a first side surface portion substantially parallel to the folding axis;
a second side surface portion opposite to the first side surface portion and substantially parallel to the folding axis;
a third side surface portion substantially perpendicular to the folding axis; and
a fourth side surface portion opposite to the third side surface portion and substantially perpendicular to the folding axis, and
wherein the second buffer member is formed along the first side surface portion.

13. The foldable electronic device of claim 12, wherein the second buffer member extends at least partially along at least one of the third side surface portion and the fourth side surface portion.

14. The foldable electronic device of claim 12, wherein the first buffer member is formed along the first side surface portion, the third side surface portion, and the fourth side surface portion.

15. The foldable electronic device of claim 12, wherein the second buffer member is formed along the first side surface portion, and is not formed along the third side surface portion and the fourth side surface portion.

16. The foldable electronic device of claim 1, wherein when the flexible display is unfolded, a boundary surface between the first buffer member and the second buffer member is inclined in a manner in which the boundary surface is closer to the inner surface as the boundary surface extends from the rear side to the front side of the foldable electronic device.

17. The foldable electronic device of claim 1, wherein the first buffer member includes:
a first buffer part disposed between the second buffer member and the inner surface and at least partially in contact with the inner surface; and
a second buffer part disposed between the second layer part and the inner surface and at least partially spaced from the inner surface.

18. The foldable electronic device of claim 1, further comprising a film member disposed over the first buffer member and the second buffer member.

19. The foldable electronic device of claim 1, further comprising a coating layer formed on one side of the flexible display, an upper surface of the first buffer member and an upper surface of the second buffer member,
wherein a printing layer included in the coating layer is opaquely in an area corresponding to the first buffer member and the second buffer member.

20. The foldable electronic device of claim 1, wherein an upper ending part of the first buffer member extends between the second buffer member and the inner surface and covers at least a portion of the second buffer member.
